(19) United States
(12) Patent Application Publication
(10) Pub. No.: US 2026/0192715 A1
(43) Pub. Date: Jul. 9, 2026

(54) CHILD VEHICLE SEAT SYSTEM

(71) Applicant: WONDERLAND SWITZERLAND AG, Steinhausen (CH)

(72) Inventors: Kyle S. MASON, Morgantown, PA (US); David A. LEHMAN, Morgantown, PA (US); Nathaniel W. KEEBLER, Morgantown, PA (US); Leif MALM, Morgantown, PA (US); Curtis M. Hartenstine, Morgantown, PA (US)

(21) Appl. No.: 19/130,849

(22) PCT Filed: Nov. 29, 2023
(86) PCT No.: PCT/US2023/081524

§ 371 Date: May 16, 2025

Related U.S. Application Data
(60) Provisional application No. 63/385,444, filed on Nov. 30, 2022.
(60) Provisional application No. 63/484,148, filed on Feb. 9, 2023.
(60) Provisional application No. 63/504,355, filed on May 25, 2023.
(60) Provisional application No. 63/517,463, filed on Aug. 3, 2023.
(60) Provisional application No. 63/588,521, filed on Oct. 6, 2023.

(51) Int. Cl. B60N 2/28

(52) U.S. Cl. CPC B60N 2/2869; B60N 2/2821; B60N 2/2845

(57) ABSTRACT

A child seat system installable on a vehicle seat, the child seat system including a support base securable to the vehicle seat and a seat detachably connectable to the support base. The seat includes a seat portion and a back portion extending in an upward direction from the seat portion. The seat is configured to transition between a first configuration and a second configuration. In the first configuration, the seat can receive and support a child seated on the seat portion and in the second configuration, the seat is unable to receive or support the child on said seat portion. The seat is configured to transition from the second configuration to the first configuration by connecting the seat to the support base.

### CROSS REFERENCE TO RELATED APPLICATIONS

This application claims the benefit of U.S. Application No. 63/385,444, filed on Nov. 30, 2022, U.S. Application No. 63/484,148, filed on Feb. 9, 2023, U.S. Application No. 63/504,355, filed on May 25, 2023, U.S. Application No. 63/517,463, filed on Aug. 3, 2023, and U.S. Application No. 63/588,521, filed on Oct. 6, 2023, which are incorporated herein by reference in their entirety.

### FIELD

Embodiments of the present disclosure relate to the art of child restraint systems for use in a vehicle, and more particularly to a support base of a child restraint system.

### BACKGROUND

A child restraint system is designed to protect a child from injury or death during a collision of a vehicle. Existing child restraint systems commonly include a base portion and a seat portion detachably installed on the base portion. When a child restraint system is secured on a vehicle by a lower anchor or a vehicle belt, the base portion must be adjusted to a proper reclined angle. In addition, depending on the type of seat that is being used, the seat may be position either in a forward-facing or a rearward-facing orientation. Existing base portions cannot support different type of seats in different orientations and at various angles of recline.

### BRIEF DESCRIPTION

According to an embodiment, a child seat system installable on a vehicle seat, the child seat system including a support base securable to the vehicle seat and a seat detachably connectable to the support base. The seat includes a seat portion and a back portion extending in an upward direction from the seat portion. The seat is configured to transition between a first configuration and a second configuration. In the first configuration, the seat can receive and support a child seated on the seat portion and in the second configuration, the seat is unable to receive or support the child on the seat portion. The seat is configured to transition from the second configuration to the first configuration by connecting the seat to the support base.

In addition to one or more of the features described above, or as an alternative, in further embodiments the seat is a toddler seat.

In addition to one or more of the features described above, or as an alternative, in further embodiments an infant car seat is detachably connectable to the support base.

In addition to one or more of the features described above, or as an alternative, in further embodiments the seat has an inner seat surface that defines a seating area. The seating area is sized to support the child therein. The seat includes a block member and in the first configuration, the block member is outside of the seating area. In the second configuration, the block member extends at least partially into the seating area.

In addition to one or more of the features described above, or as an alternative, in further embodiments the seating area is at least partially defined by the seat portion.

In addition to one or more of the features described above, or as an alternative, in further embodiments the seating area is at least partially defined by the back portion.

In addition to one or more of the features described above, or as an alternative, in further embodiments in the first configuration, the block member is positioned within a recess defined by the back portion.

In addition to one or more of the features described above, or as an alternative, in further embodiments in the first configuration, the block member is positioned within a recess defined by the seat portion.

In addition to one or more of the features described above, or as an alternative, in further embodiments the block member is rotatable relative to the seat.

In addition to one or more of the features described above, or as an alternative, in further embodiments the block member defines a general U-shape. The block member includes opposing ends connected to the seat and a handle portion positioned between the opposing ends. In the second configuration, the handle portion is accessible by a user to lift the seat.

In addition to one or more of the features described above, or as an alternative, in further embodiments when the seat is disconnected from the support base, the seat is locked in the second configuration.

In addition to one or more of the features described above, or as an alternative, in further embodiments the seat includes a first lock. The first lock is configured to transition between an unlocked position and a locked position. In the unlocked position, the block member is free to move relative to the seat, and in the locked position, the block member is substantially prevented from moving relative to the seat. The first lock is transitionable from the locked position to the unlocked position when the seat is connected to the support base.

In addition to one or more of the features described above, or as an alternative, in further embodiments when the seat is detached from the support base the first lock is prevented from transitioning from the locked position to the unlocked position.

In addition to one or more of the features described above, or as an alternative, in further embodiments the seat includes a sensor member configured to transition the first lock from the locked position to the unlocked position.

In addition to one or more of the features described above, or as an alternative, in further embodiments the support base includes a lock member lock release operatively connectable to the first lock such that the lock member lock release transitions the first lock from the locked position to the unlocked position when the seat is connected to the support base.

In addition to one or more of the features described above, or as an alternative, in further embodiments when the seat is connected to the support base, the seat is prevented from being detached from the support base when the seat is in the first configuration, and wherein the seat is free to be detached from the support base when the seat is in the second configuration.

According to an embodiment, a child seat detachably connectable to a support base, the support base is installable on a vehicle seat, the child seat includes a seat body having an inner surface that defines a seating area sized to support a child therein and a block member connected to the seat body. The child seat is configured to transition between a first configuration and a second configuration. In the first configuration, the block member is in a first position outside of the seating area and the child seat can receive and support the child within the seating area. In the second configuration, the block member is in a second position at least partially extending into the seating area and the child seat is unable to receive or support the child within the seating area. The child seat is configured to transition from the second configuration to the first configuration by connecting the seat to the support base.

According to an embodiment, a support base for detachably receiving a child seat thereon, the support base is installable on a vehicle seat, the child seat includes a seat body defining a seating area sized to receive a child and a disablement assembly connected to the seat body. The disablement assembly is configured to transition between a first configuration in which the child is receivable within the seating area and a second configuration in which the child is not receivable within the seating area. The support base includes a support base body having a lock member lock release operatively connectable to the disablement assembly. When the child seat is connected to the support base, the lock member lock release transitions a first lock of the disablement assembly from a locked position to an unlocked position. In the unlocked position the disablement assembly is free to transition from the second configuration to the first configuration.

According to an embodiment, a child seat system installable on a vehicle seat, the child seat system includes a support base securable to the vehicle seat and a seat detachably connectable to the support base. The seat includes a seat body having an inner surface that defines a seating area sized to support a child within and a block member connected to the seat body. The child seat is configured to transition between a first configuration and a second configuration. In the first configuration, the block member is in a first position outside of the seating area and the seat can receive and support the child within the seating area. In the second configuration, the block member is in a second position at least partially extending into the seating area and the seat is unable to receive or support the child within the seating area. The seat is configured to transition from the second configuration to the first configuration by connecting the seat to the support base.

In addition to one or more of the features described above, or as an alternative, in further embodiments the seat further includes a first lock. The first lock is configured to transition between an unlocked position and a locked position. In the unlocked position, the block member is free to move relative to the seat. In the locked position the block member is substantially prevented from moving relative to the seat.

In addition to one or more of the features described above, or as an alternative, in further embodiments the first lock is operatively connectable to the support base such that the first lock is transitionable from the locked position to the unlocked position when the seat is connected to the support base.

In addition to one or more of the features described above, or as an alternative, in further embodiments the seat further includes a second lock configured to transition between an unlocked position and a locked position. In the unlocked position, the seat is detachable from the support base and in the locked position, the seat is prevented from being detached from the support base.

In addition to one or more of the features described above, or as an alternative, in further embodiments the second lock is operatively connected to the block member such that the second lock is transitionable from the locked position to the unlocked position when the block member transitions from the first position to the second position.

According to an embodiment, a child seat system installable on a vehicle seat includes a support base securable to the vehicle seat and a toddler seat detachably connectable to the support base. The toddler seat includes a seat portion, a back portion extending in an upward direction from the seat portion, and a harness assembly. The harness assembly includes an upper harness portion connected to the back portion of the toddler seat and a lower harness portion connected to the support base. When the toddler seat is connected to the support base, the lower harness portion is connectable with the upper harness portion to retain a child on the seat portion within the toddler seat.

In addition to one or more of the features described above, or as an alternative, in further embodiments when the toddler seat is removed from the support base, the lower harness portion is not connectable with the upper harness portion to retain the child on the seat portion of the toddler seat.

According to an embodiment, a child seat system installable on a vehicle seat includes a support base securable to the vehicle seat and a toddler seat detachably connectable to the support base. The toddler seat includes a seat portion having a bottom seat surface and an opposing upper seat surface configured to support a child on the toddler seat and a back portion extending in an upward direction from the seat portion. When the support base is secured to the vehicle seat, the toddler seat is connectable to the support base by lowering the toddler seat on top of the support base in a placement direction orienting the upper seat surface at a first angle orientation. When the toddler seat is positioned on the vehicle seat by lowering the toddler seat on top of the vehicle seat in the placement direction, the bottom seat surface of the toddler seat contacts the vehicle seat orienting the upper seat surface at a second angle orientation.

According to an embodiment, a child seat system installable on a vehicle seat includes a support base securable to the vehicle seat and a toddler seat detachably connectable to the support base. When the toddler seat is connected to the support base, the toddler seat is oriented at a first angle orientation. The toddler seat includes a seat portion having a bottom seat surface and an opposing upper seat surface configured to support a child on the toddler seat and a back portion extending in an upward direction from the seat portion. A shape of the bottom seat surface causes the toddler seat to be oriented at a second angle orientation when the seat portion is positioned directly on the vehicle seat.

According to an embodiment, a child seat system installable on a vehicle seat, the child seat system includes a support base securable to the vehicle seat and a toddler seat detachably connectable to the support base. The toddler seat includes a seat portion having a bottom seat surface and an opposing upper seat surface configured to support a child on the toddler seat. The bottom seat surface includes a protrusion extending therefrom. The toddler seat also includes a back portion extending in an upward direction from the seat portion. When the toddler seat is connected to the support base positioned on the vehicle seat, the upper seat surface is oriented at a first angle orientation. When the toddler seat is connected directly to the vehicle seat, the protrusion causes the upper seat surface to be oriented at a second angle orientation.

In addition to one or more of the features described above, or as an alternative, in further embodiments the protrusion defines a point load.

According to an embodiment, a child seat system installable on a vehicle seat includes a support base securable to the vehicle seat and a seat detachably connectable to the support base and having a seating area. The seat is transformable between an occupant receiving configuration and an occupant preventing configuration. In the occupant preventing configuration, the seat is structurally incapable of receiving or supporting the child in the seat region.

In addition to one or more of the features described above, or as an alternative, in further embodiments including a tool configured to engage the seat to allow removal of the seat from the support base. The tool remains engaged with the seat when the seat is separated from the support base.

In addition to one or more of the features described above, or as an alternative, in further embodiments the tool is engaged with the seat in the occupant preventing configuration.

In addition to one or more of the features described above, or as an alternative, in further embodiments the seat is only connectable to the support base when the tool is engaged with the seat.

In addition to one or more of the features described above, or as an alternative, in further embodiments the seat is not separable from the support base when the tool is separated from the seat.

In addition to one or more of the features described above, or as an alternative, in further embodiments the tool is not engaged with the seat in the occupant receiving configuration.

In addition to one or more of the features described above, or as an alternative, in further embodiments the seat is connected to the support base in the occupant receiving configuration.

In addition to one or more of the features described above, or as an alternative, in further embodiments at least one lock is operable to selectively interlock the seat to the support base. The at least one lock is actuatable by the tool.

In addition to one or more of the features described above, or as an alternative, in further embodiments the at least one lock includes a seat lock attached to the seat. The seat lock is receivable within an opening formed in the support base to couple the seat to the support base.

In addition to one or more of the features described above, or as an alternative, in further embodiments the seat lock is receivable within the opening in response to separation of the tool from the seat.

In addition to one or more of the features described above, or as an alternative, in further embodiments the seat lock is in a locked position when the seat is in the occupant receiving configuration.

In addition to one or more of the features described above, or as an alternative, in further embodiments the at least one lock includes a tool lock attached to the seat. The tool lock is selectively engageable with the tool to couple the tool to the seat.

In addition to one or more of the features described above, or as an alternative, in further embodiments the tool lock includes a tool engagement feature and the tool includes an opening. The tool engagement feature is receivable within the opening in response to separation of the seat from the support base.

In addition to one or more of the features described above, or as an alternative, in further embodiments the tool lock is in a locked position when the seat is in the occupant preventing configuration.

### BRIEF DESCRIPTION OF THE DRAWINGS

The following descriptions should not be considered limiting in any way. With reference to the accompanying drawings, like elements are numbered alike:

FIG. 1A is a perspective view of a support base of a child seat system according to an embodiment;

FIG. 1B is a side view of a support base of a child seat system according to an embodiment;

FIG. 2 is a perspective view of a seat receiving assembly of the support base of FIG. 1 according to an embodiment;

FIG. 3 is an exploded perspective view of the seat receiving assembly of FIG. 2 according to an embodiment;

FIG. 4 is a perspective view of the base member and a portion of the seat receiving assembly according to an embodiment;

FIG. 5 is a top view of the incline member according to an embodiment;

FIG. 6 is a perspective view of a seat attachment of the seat receiving assembly according to an embodiment;

FIG. 7 is a perspective view of a portion of the seat receiving assembly according to an embodiment;

FIG. 8 is a cross-sectional view of the support base including a portion of the seat receiving assembly according to an embodiment;

FIG. 9 is a top view of the incline member and a portion of the base member according to an embodiment;

FIG. 10 is a side view of the incline member and a corresponding portion of the base member according to an embodiment;

FIG. 11A is a perspective view of a portion of the support plate of the seat receiving assembly according to an embodiment;

FIG. 11B is a perspective view of an interior portion of the base body according to an embodiment;

FIG. 12A is a perspective view of the support plate mounted within the base body when the incline member is at a first inclined position according to an embodiment;

FIG. 12B is a perspective view of the support plate mounted within the base body when the incline member is at a second inclined position according to an embodiment;

FIG. 13A is a perspective view of a first child seat mounted to the support base in a first inclined position and a first rotational configuration according to an embodiment;

FIG. 13B is a perspective view of a first child seat mounted to the support base in a first inclined position and a second rotational configuration according to an embodiment;

FIG. 14A is a perspective view of a second child seat mounted to the support base in a first inclined position and a first rotational configuration according to an embodiment;

FIG. 14B is a perspective view of a second child seat mounted to the support base in a first inclined position and a second rotational configuration according to an embodiment;

FIG. 15A is a perspective view of a first child seat mounted to the support base in a second inclined position and a first rotational configuration according to an embodiment;

FIG. 15B is a perspective view of a first child seat mounted to the support base in a second inclined position and a second rotational configuration according to an embodiment;

FIG. 16A is a perspective view of a second child seat mounted to the support base in a second inclined position and a first rotational configuration according to an embodiment;

FIG. 16B is a perspective view of a second child seat mounted to the support base in a second inclined position and a second rotational configuration according to an embodiment;

FIG. 17 is a side view of a support base installed on a vehicle seat according to an embodiment;

FIG. 18 is a front view of a support base having a vehicle belt extending through a belt receiving path of the support base according to an embodiment;

FIG. 19 is a perspective view of a convertible child seat configured to mount to a support body according to an embodiment;

FIG. 20 is a perspective view of a convertible child seat configured to mount to a support body according to an alternative embodiment;

FIG. 21 is a perspective view of a convertible child seat configured to mount to a support body according to another alternative embodiment;

FIGS. 22A, 22B, and 22C are side cross-sectional views of the convertible child seat shown in FIG. 21;

FIG. 23 is a perspective view of a convertible child seat configured to mount to a support body according to another alternative embodiment;

FIG. 24 is a top perspective view of the convertible child seat shown in FIG. 23;

FIG. 25 is a perspective view of a convertible child seat configured to mount to a support body according to another alternative embodiment;

FIG. 26 is a side cross-sectional view of the convertible child seat shown in FIG. 25;

FIG. 27 is a perspective view of a convertible child seat configured to mount to a support body according to another alternative embodiment;

FIGS. 28A and 28B are perspective views of a convertible child seat configured to mount to a support body according to another alternative embodiment;

FIGS. 29A and 29B are perspective views of a convertible child seat configured to mount to a support body according to another alternative embodiment;

FIGS. 30A and 30B are perspective views of a convertible child seat configured to mount to a support body according to another alternative embodiment;

FIGS. 31, 32, and 33 are perspective views of convertible child seats configured to mount to a support body according to other alternative embodiments;

FIG. 34 is a perspective view of a child seat system including a child seat having a disablement assembly in a first configuration according to other alternative embodiments;

FIG. 35 is a perspective view of the child seat system of FIG. 34 having a disablement assembly in a second configuration according to other alternative embodiments;

FIG. 36 is an exploded perspective view of the convertible child seat of FIG. 35 according to other alternative embodiments;

FIG. 37A is a perspective view of the disablement assembly in a second configuration according to other alternative embodiments;

FIG. 37B is another perspective view of the disablement assembly in a second configuration according to other alternative embodiments;

FIG. 38 is a perspective view of a seat including a disablement assembly in a second configuration according to other alternative embodiments;

FIG. 39 is a perspective view of the seat of FIG. 38 with the seat body being transparent according to other alternative embodiments;

FIG. 40 is a perspective view of a seat having a disablement assembly with a first lock in a locked position according to other alternative embodiments;

FIG. 41 is a perspective view of the seat of FIG. 40 with the first lock in an unlocked position according to other alternative embodiments;

FIG. 42A is a perspective view of the disablement assembly in a first configuration according to other alternative embodiments;

FIG. 42B is another perspective view of the disablement assembly in a first configuration according to other alternative embodiments;

FIG. 43 is a perspective view of a seat including a transparent seat body and having a disablement assembly in a first configuration according to other alternative embodiments;

FIG. 44 is a perspective view of the seat of FIG. 43 according to other alternative embodiments;

FIG. 45 is a perspective view of a portion of a support base configured to cooperate with the disablement assembly according to an embodiment;

FIG. 46A is a perspective view of a seat having a disablement assembly, the seat being separated from the support base according to an embodiment;

FIG. 46B is a perspective view of a seat in an occupant preventing configuration according to an embodiment;

FIG. 47 is a perspective view of a seat in an occupant receiving configuration according to an embodiment;

FIG. 48 is a perspective view of a tool of a disablement assembly according to an embodiment;

FIG. 49 is a perspective view of a first lock of a disablement assembly according to an embodiment;

FIG. 50 is a perspective view of a second lock of a disablement assembly according to an embodiment;

FIG. 51 is a perspective view of a seat having a disablement assembly according to an embodiment;

FIG. 52 is a perspective view of a first lock and second lock of a disablement assembly when the seat is in an occupant preventing configuration according to an embodiment;

FIG. 53 is a cross-sectional view of the first lock and second lock of FIG. 53 according to an embodiment;

FIG. 54 is a perspective view of a seat having a disablement assembly and a support base according to an embodiment;

FIG. 55 is a cross-sectional view of the disablement assembly of FIG. 54 as the seat transforms from an occupant preventing configuration to an occupant receiving configuration according to an embodiment;

FIG. 56 is a perspective view of a first lock and second lock of a disablement assembly as the seat transforms from an occupant preventing configuration to an occupant receiving configuration according to an embodiment;

FIG. 57 is a perspective view of a seat in having a tool rotated to a second configuration according to an embodiment;

FIG. 58 is a perspective view of a first lock and second lock of a disablement assembly of FIG. 57 according to an embodiment;

FIG. 59 is a cross-sectional view of the disablement assembly of FIG. 58 according to an embodiment;

FIG. 60 is a perspective view of a seat in an occupant receiving configuration according to an embodiment;

FIG. 61 is a perspective view of a first lock and second lock of a disablement assembly of FIG. 60 according to an embodiment;

FIG. 62 is a perspective view of a disablement assembly according to another embodiment;

FIG. 63 is a perspective view of a disablement assembly of FIG. 62 when the toddler seat is separated from a support base according to an embodiment;

FIG. 64 is a perspective view of the disablement assembly of FIG. 62 when the toddler seat is attached to a support base and prior to rotation of the tool according to an embodiment; and

FIG. 65 is a perspective view of a disablement assembly of FIG. 62 when the toddler seat is locked to a support base according to an embodiment.

### DETAILED DESCRIPTION

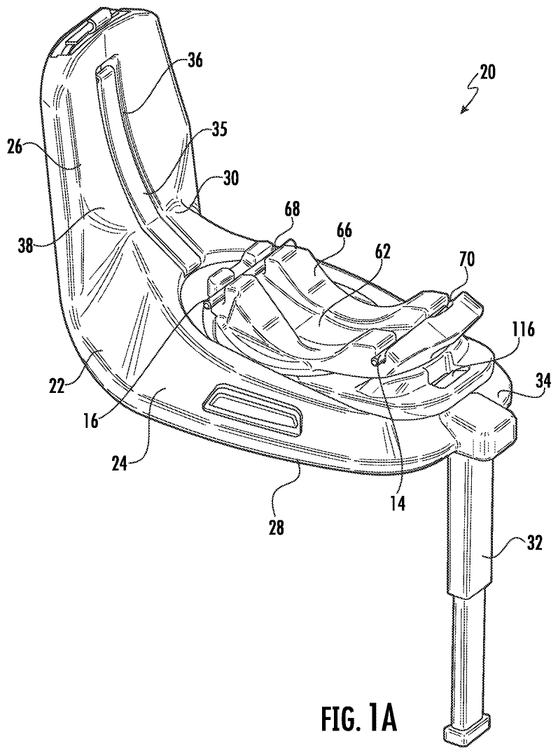

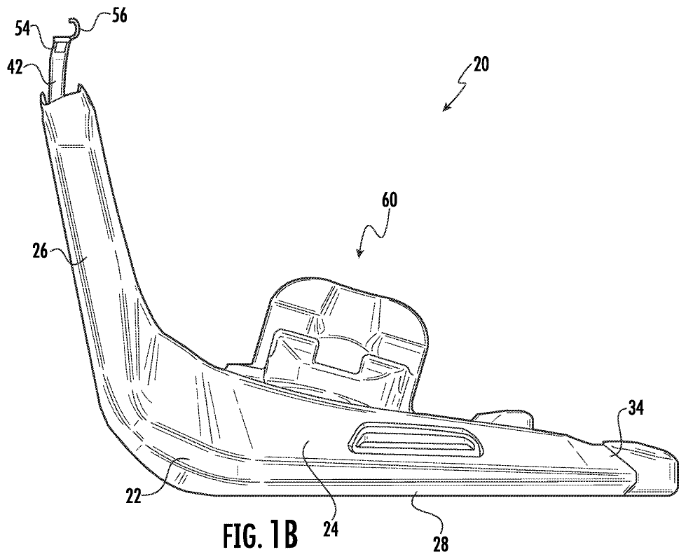

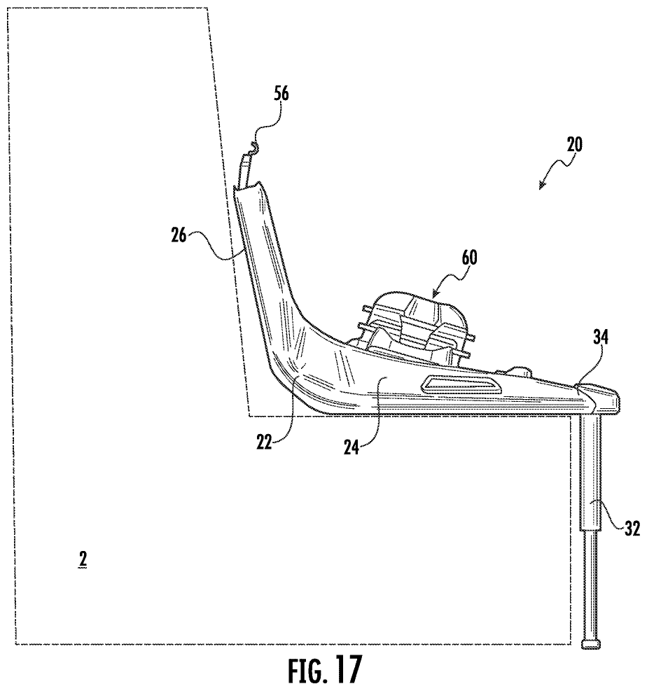

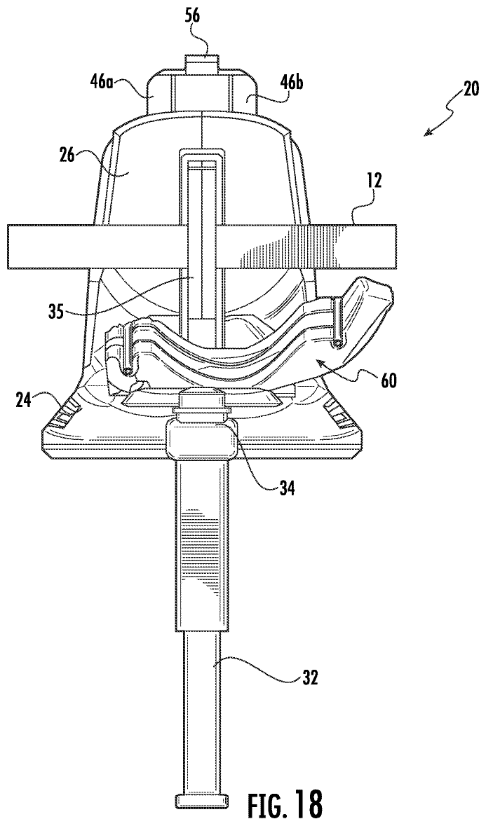

A detailed description of one or more embodiments of the disclosed apparatus and method are presented herein by way of exemplification and not limitation with reference to the Figures. With reference now to the FIG. 1, an example of a support base 20 for use in a child restraint system or child seat system and that is configured to receive a child safety seat is illustrated according to an embodiment. The support base 20 can be detachably fixed to or installable on a vehicle seat 2 (FIG. 17), such as via a latch or anchor mechanism, not shown in the FIGS. This latch or anchor system often used is sometimes referred to as a “lower anchor and tether for children” e.g., LATCH system. Alternatively, or in addition, as will be described in more detail below, the support base 20 may be detachably fixed to a vehicle seat 2 via a vehicle belt 12 (see FIG. 18) associated with the vehicle seat 2.

As shown, the support base 20 includes a base body 22 having a seat portion 24 and a back portion 26. Suitable materials for making the base body 22 include but are not limited to rigid plastic or composite materials for example. Although the seat portion 24 and the back portion 26 are illustrated as being integrally formed as a unitary body, embodiments where the seat portion 24 and the back portion 26 are separate components removably or permanently connected together are also within the scope of the disclosure. The seat portion 24 has a bottom surface 28 suitable for placement on a support surface, such as a vehicle seat (see FIG. 17). The back portion 26 may be arranged at a first end 30 of the seat portion 24 and extends at an angle relative thereto. In the illustrated, non-limiting embodiment, the back portion 26 is oriented at an angle between about 75 degrees and about 120 degrees relative to the bottom surface 28 of the seat portion 24. However, it should be understood that embodiments where the angle formed between the back portion 26 and the bottom surface of the seat portion 24 is less than 75 degrees or is greater than 120 degrees are also contemplated herein.

In the illustrated, non-limiting embodiment, a stability leg 32 having a fixed or adjustable length is connected to a portion of the base body 22, such as the second, opposite end 34 of the seat portion 24 for example. The stability leg 32 can be rotatable or foldable relative to the seat portion 24 between an extended configuration (FIG. 1A), in which the stability leg 32 abuts against a vehicle floor, and a retracted configuration (FIG. 1B), in which the stability leg 32 is stowed underneath or within the seat portion 24 of the support base 20. When in the retracted configuration, the stability leg may protrude slightly from the bottom surface 28 of the seat portion 24 such as to encourage the use of the stability leg 32 during installation of the support base 20 about a vehicle seat 2.

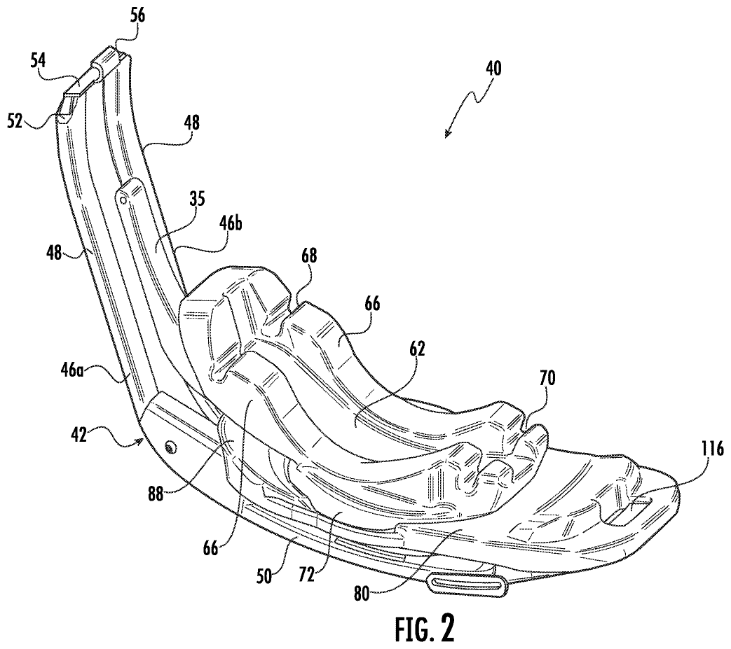

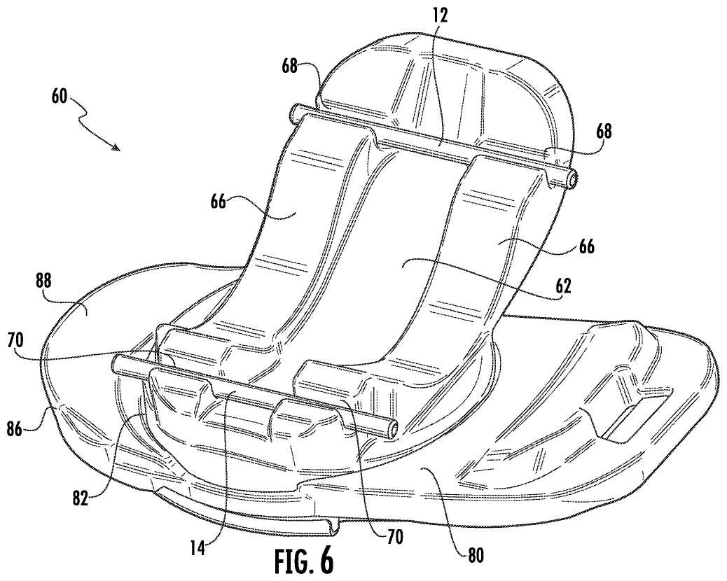

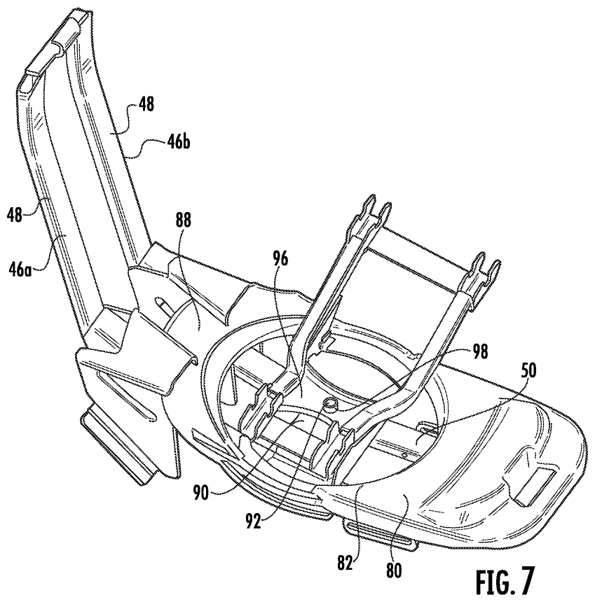

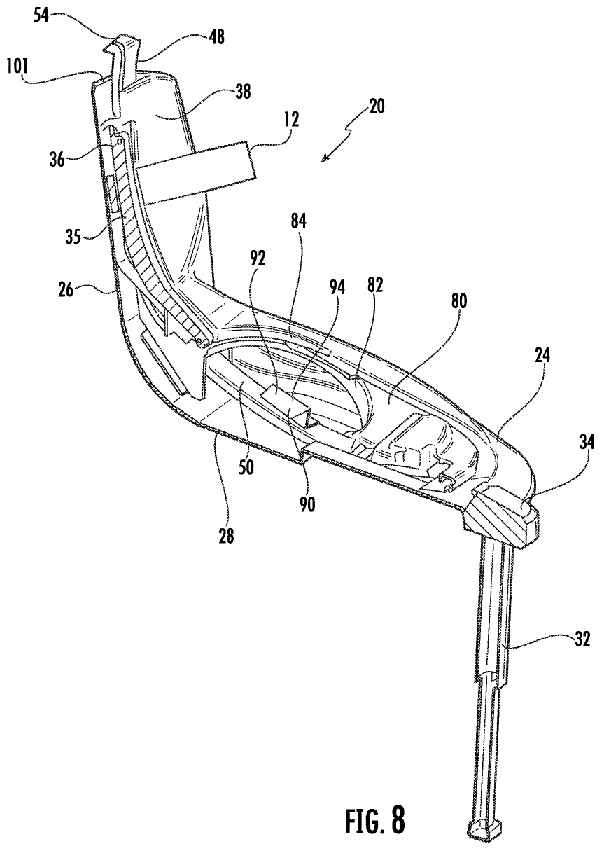

With continued reference to FIG. 1A, and further reference to FIGS. 2-4, 8 and 16, the support base 20 may include a belt tensioner 35 coupled to the base body 22. In the illustrated, non-limiting embodiment, a groove 36 formed in the base body 22 extends from the seat portion 24 into the back portion 26 and the belt tensioner 35 is receivable within the groove 36. However, it should be appreciated that embodiments where the groove 36 is only formed in the back portion 26 of the base body 22 are also contemplated herein. A contour of the belt tensioner 35 may be complementary to that of the groove 36 such that the substantial entirety of the belt tensioner 35 is receivable within the groove 36. A vehicle belt 12 associated with the vehicle seat on which the support base 20 is positionable may be arranged along a belt receiving path defined between an exterior or top surface 38 of the base body 22, such as of the back portion 26 of the base body 22 for example, and the belt tensioner 35. In an embodiment, the belt tensioner 35 is selectively movable relative to the base body 22 to adjust the tension applied to the vehicle belt 12 along the vehicle belt receiving path. For example, the belt tensioner 35 may be configured to pivot about an axis to selectively pinch the portion of the vehicle belt 12 sandwiched between the belt tensioner 35 and the groove 36 to couple the support base 20 to the vehicle belt 12, thereby restricting movement of the support base 20 relative to the vehicle seat.

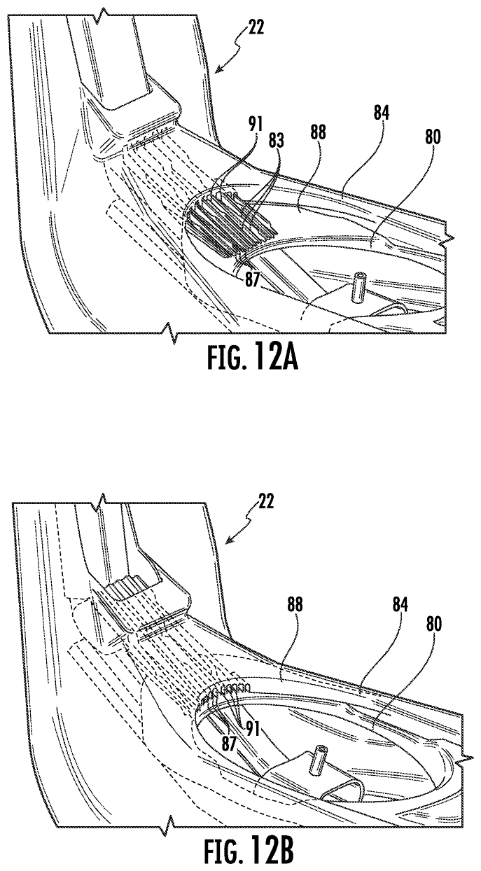

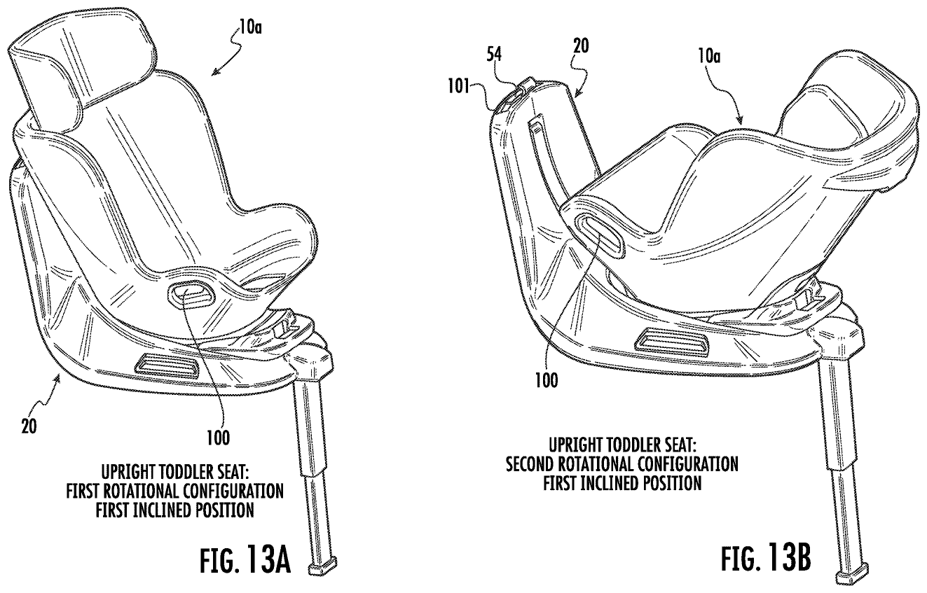

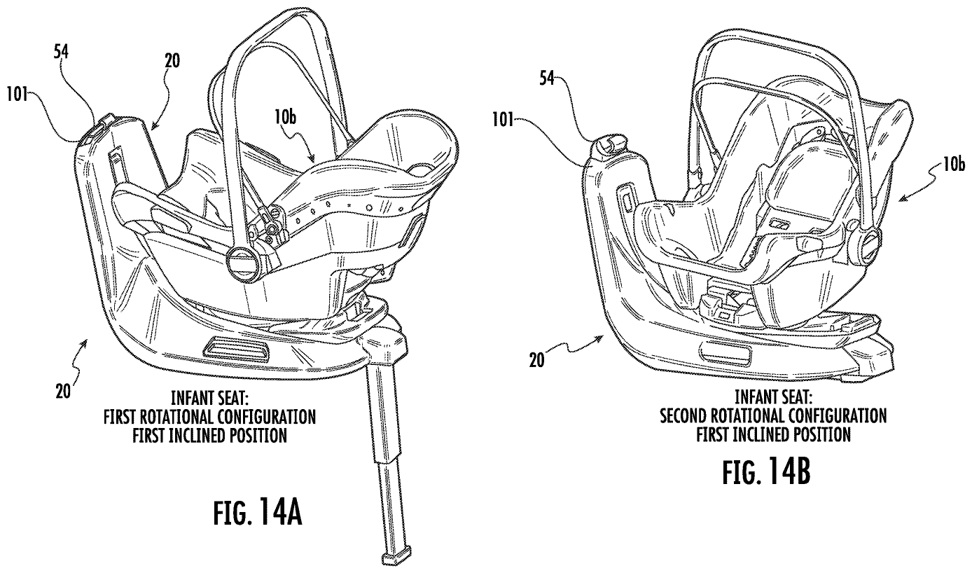

At least one child seat is detachably connectable to the support base 20. In combination, the support base 20 and the child seat 10 mountable thereon form a child seat system that is installable on a vehicle seat. As shown, the support base 20 additionally includes a seat receiving assembly 40 coupled to the base body 22. The seat receiving assembly 40 may be configured to receive and couple at least one child seat to the support base 20. In an embodiment, a plurality of child seats are interchangeably mountable to the seat receiving assembly 40. For example, a first child seat 10a (FIGS. 13A-13B) detachably connectable to the seat receiving assembly 40 is a convertible child seat, and a second child seat 10b (FIGS. 14A-14B) detachably connectable to the seat receiving assembly 40 is an infant car seat. As used herein, the term “convertible child seat” refers to a seat that may be used in both a rearward and forward-facing direction such as suitable for use by a child between 5 and 65 pounds, and/or up to 49″ in height. The convertible child seat may also be referred to herein as an upright child seat or a toddler seat. Similarly, as used herein, the term “infant car seat” refers to such a seat as would be defined by one of ordinary skill in the art. For example, an infant child seat may be described as a seat for use by an infant or child too small to use a convertible child seat and may include a carrying handle to allow for portability of the infant car seat external to the vehicle. However, embodiments where another type of child seat is alternatively or additionally connectable to the seat receiving assembly 40 are also contemplated herein.

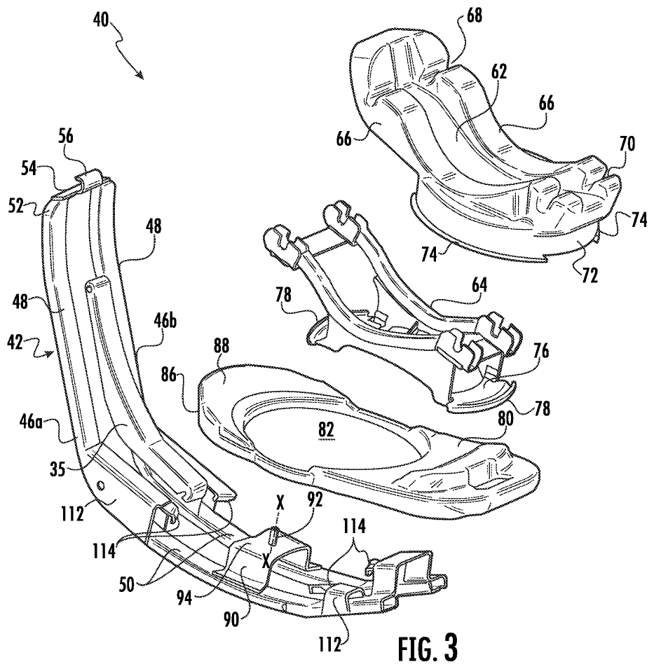

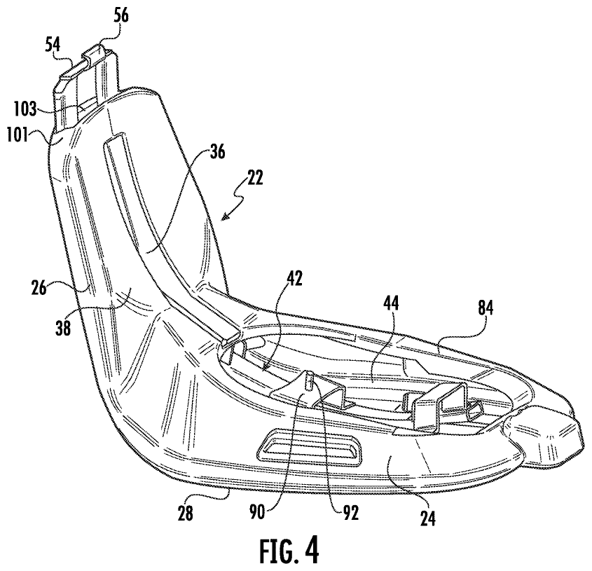

The seat receiving assembly 40 includes an incline member 42 generally arranged within the interior 44 of the base body 22 (see FIG. 4). With reference to FIGS. 2-5, the incline member 42 has a first leg 46a and a second leg 46b offset from one another by a distance. Although the first and second legs 46a, 46b are illustrated as being substantially identical, it should be appreciated that in other embodiments, a configuration of the first and second legs 46a, 46b may vary. In the illustrated, non-limiting embodiment, both the first leg 46a and the second leg 46b have an upper portion 48 and a lower portion 50, respectively. The upper portion 48 and the lower portion 50 may be defined by a bend formed in each of the first and second legs 46a, 46b. Accordingly, the upper portion 48 of each of the legs 46a, 46b is arranged at a non-parallel angle relative to the lower portion 50 thereof. The upper portion 48 of each leg 46a, 46b may be arranged within the back portion 26 of the base body 22 and the lower portion 50 of each leg 46a, 46b may be arranged within the seat portion 24 of the base body 22. Because of this positioning, the angle between the upper portion 48 and the lower portion 50 may be identical to, or may be different from, the angle formed between the seat portion 24 and the back portion 26 of the base body 22.

The upper portion 48 of the first and second legs 46a, 46b may have a substantially linear configuration and the lower portion 50 of the first and second legs 46a, 46b may have a generally curved configuration. For example, as shown, the lower portion 50 of the first and second legs 46a, 46b have a generally concave curvature. However, embodiments where the lower portion 50 of the first and second legs 46a, 46b have a different curvature or a linear configuration are also contemplated herein. Further, the distal ends 52 of the upper portion 48 of each leg 46a, 46b may be coupled by a connecting member 54. The connecting member 54 may extend generally perpendicularly or orthogonally to the upper portion 48 of the legs 46a, 46b.

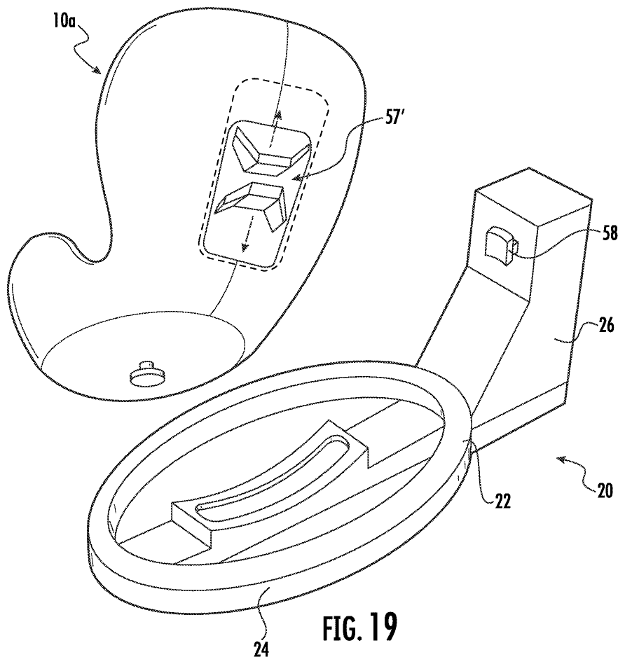

At least one base anchor member 56 may be fixedly connected to the incline member 42. In the illustrated, non-limiting embodiment, a base anchor member 56 is affixed to and protrudes from the connecting member 54 of the incline member 42. The base anchor member 56 is connectable to a corresponding seat anchor member 57 (see FIG. 19) of a child seat when the child seat is attached to the seat receiving assembly 40. Such a seat anchor member is typically arranged at a surface of a back portion of a convertible child seat 10a (e.g., located behind the child's back), and therefore the base anchor member 56 is connectable thereto when the child seat is in a forward-facing configuration. This second connection between the base anchor member 56 and the seat anchor member 57 further stabilizes the back portion of the child seat. In such embodiments, the base anchor member 56 may not be connectable to the seat anchor member 57 when the child seat is in a rearward-facing configuration. However, it should be understood that the base anchor member 56 may be suitable for use with a seat anchor member 57 arranged at any location about a child seat.

Alternatively, or in addition, with reference to FIG. 19, a portion of the base body 22, such as the back portion 26 for example, may include a base anchor member 58 configured to connect to a corresponding seat anchor member 57′ of a child seat. In the illustrated, non-limiting embodiment, the base anchor member 58 may be fixedly mounted to the base body 22. The seat anchor member 57′ associated with the child seat may be fixed or may be movable about the child seat to accommodate a connection with the base anchor member 58 when the child seat is in multiple positions, such as in a first inclined position and a second inclined position, as will be described in more detail below. Alternatively, base anchor member 58 may be movable about the base body 22, and the seat anchor member 57′ may be fixedly mounted to the child seat. The configurations of the seat anchor member 57′ and the base anchor member 58 allows the connection between the seat anchor member 57′ and the base anchor member 58 to move relative to either one of the child seat and the base body 22 when the child seat transitions between the first inclined position and the second inclined position, as will be described in more detail below.

Alternatively, or in addition, the seat anchor member 57′ may be designed with a self-centering feature to facilitate alignment or connection with the base anchor member 58 regardless of the position of the seat anchor member 57′ along its path of movement relative to the child seat. In an embodiment, the self-centering feature includes angled contact surfaces configured to engage the base anchor member 56/58 to center itself relative to the attachment point of the base anchor member 56/58. As will be described in more detail below, the base anchor members 56 and/or 58 are typically disengaged from the corresponding seat anchor member 57′ before the child seat 10 affixed to the seat receiving assembly 40 is rotated about an axis relative to the support base 20.

With continued reference to FIGS. 2 and 3 and further reference to FIGS. 6-7, the seat receiving assembly 40 additionally includes a seat attachment 60. In the illustrated, non-limiting embodiment, the seat attachment 60 includes a support platform 62 and an attachment member 64, the support platform 62 being positionable in overlapping arrangement with the attachment member 64. The support platform 62 may include two guide rails 66 that are adapted to receive and couple to a corresponding portion of a child seat 10a, 10b to lock the child seat to the seat attachment 60. The guide rails 66 may be symmetrical and substantially identical as shown. In the illustrated, non-limiting embodiment, each guide rail 66 includes a first groove 68 and a second groove 70 spaced apart from the first groove 68. The first and second grooves 68, 70 can be formed as recesses in the upper surfaces of the guide rails 66 and are sized to receive and hold a part of a component, such as a shaft 14, 16 (FIG. 2) for example, arranged at the bottom or base portion of a child seat 10a, 10b. Although not shown, it should be appreciated that each of the first and second grooves 68, 70 can include a catch with which a corresponding latch (not shown) can engage to lock the child seat 10a, 10b, to the seat attachment 60.

As best shown in FIGS. 2, 3, and 6, an annular or circular collar 72 may protrude from a bottom of the support platform 62. Further, one or more flanges 74 may extend radially outwardly from the distal end of the collar 72. The flanges 74 may but need not extend about the entire periphery of the collar 72. In such embodiments, a base 76 of the attachment member 64 may also include one or more radially outwardly extending flanges 78. Accordingly, when the support platform 62 is mounted in an axially overlapping configuration to the attachment member 64 as shown, the at least one flange 78 of the attachment member 64 is arranged within the plane of the one or more flanges 74 of the collar 72. Further, the flanges 74, 78 may cooperate to form a flange that extends about the entire periphery of the collar 72.

The seat receiving assembly 40 may additionally include a support plate 80 for mounting the seat attachment 60 to the base body 22. As shown, the support plate 80 has a central opening 82 formed therein. The collar 72 of the support platform 62 and the base 76 of the attachment member 64 both extend through the opening 82 such that the flanges 74, 78 abut an underside of the support plate 80. This engagement between the flanges 74, 78 and the support plate 80 may prevent separation of the seat attachment 60 from the support plate 80.

As best shown in FIG. 4, the base body 22 has an opening 84 formed in an upper surface of the seat portion 24. The support plate 80 may be mounted to the base body 22 adjacent to or in overlapping arrangement with the opening 84 (see FIG. 1). For example, in an embodiment, a portion of the support plate 80, such as a first end 86 thereof for example, is receivable within the interior 44 of the base body 22. In the illustrated, non-limiting embodiment, a fin 88 (see FIG. 3) protruding from the support plate 80 near the first end 86 thereof is configured to abut an adjacent surface of the base body 22, such as an interior surface of the seat portion 24 for example, to restrict movement of the support plate 80 relative to the base body 22. In such embodiments, a contour of the fin 88 may be complementary to the contour of the interior surface of the seat portion 24. However, it should be appreciated that embodiments where the support plate 80 is alternatively or additionally connected to the base body 22 in another suitable manner are also within the scope of the disclosure.

When the support plate 80 is installed about the base body 22, the support plate 80 substantially seals the opening 84 of the seat portion 24. Further, the upper surface of the support platform 62 including the guide rails 66 for connecting to a child seat is arranged vertically above the support plate 80, at an exterior of the base body 22.

In an embodiment, the seat attachment 60 is movably coupled to the incline member 42. For example, the seat attachment 60 may be rotatably coupled to the incline member 42. Accordingly, the seat attachment 60 may be rotatable relative to the incline member 42, the support plate 80, and the base body 22 between a first rotational configuration, such as a configuration in which a child seat coupled to the seat receiving assembly 40 is in a facing-forward position (FIG. 13A) and a second rotational configuration, such as a configuration in which a child seat coupled to the seat receiving assembly 40 is in a rearward-facing position (FIG. 13B) or one or more other configurations (FIG. 14B).

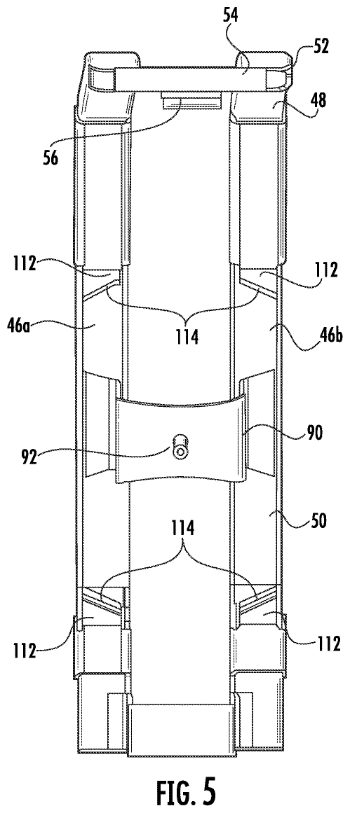

With reference to FIGS. 5, 7 and 8, in the illustrated, non-limiting embodiment, the incline member 42 includes a mounting bracket 90 coupled to the lower portion 50 of one or both of the first leg 46a and the second leg 46b. A mounting post 92 protrudes from an upper surface 94 of the mounting bracket 90. The attachment member 64 may similarly include a plate 96 having an opening 98 formed therein and the mounting post 92 is receivable within the opening 98 to define an axis of rotation X of the seat attachment 60. Accordingly, the coupled support platform 62 and attachment member 64 are rotatable in unison relative to the incline member 42, the support plate 80, and the base body 22 about the axis X.

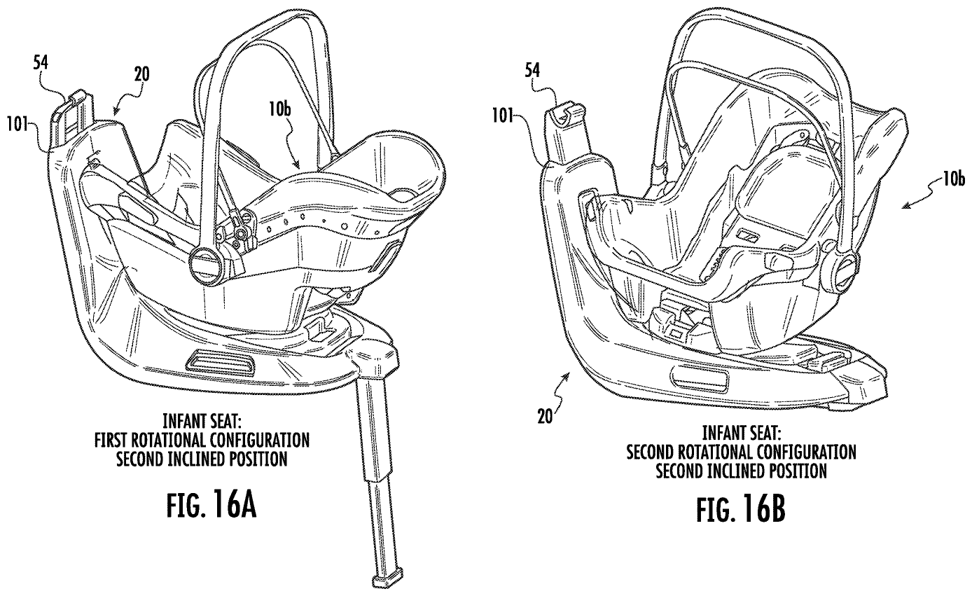

In an embodiment, the allowable rotation of the seat attachment 60 about the axis of rotation X varies based on the child seat connected thereto. For example, when a first child seat, such as a convertible child seat 10a, is coupled to the seat attachment 60, the first child seat 10a is rotatable about the axis X between a first, forward facing configuration (FIG. 13A), and a second, rearward facing configuration (FIG. 13B). The first rotational configuration and the second rotational configuration of the first child seat 10a may be arranged 180 degrees apart. When a second child seat, such as an infant car seat 10b, is attached to the seat attachment 60, the second child seat 10b may be rotatable about the axis of rotation X between a first, rearward facing configuration (FIG. 14B), and a second, side-facing configuration (FIGS. 14B and 16B). The first rotational configuration and the second rotational configuration associated with the second child seat 10b may be arranged about 90 degrees apart, or any amount less than 180 degrees. Accordingly, the allowable rotation of the seat attachment 60 when the first child seat 10a is connected to the seat attachment 60 is greater than the allowable rotation of the seat attachment 60 when the second child seat 10b is connected to the seat attachment 60. However, embodiments where the seat attachment 60 is rotatable in an identical manner when both the first and second child seats 10a, 10b are attached thereto are also contemplated herein.

As previously noted, a child seat such as the first child seat 10a for example, may have a seat anchor member 57 mounted to a back portion thereof. Accordingly, where the child seat is in the first rotational configuration, the seat anchor member is connectable to a base anchor member 56 or 58. As the child seat is rotated about the axis relative to the base to the second rotational configuration, the seat anchor member is spaced from the base anchor member 56, 58. Further, as the child seat rotates from the second rotational configuration to the first rotational configuration, the seat anchor member 57 may be configured to automatically align with the base anchor member.

Although not shown, a spin locking mechanism is associated with the seat attachment 60 and is operable to selectively lock the seat attachment 60 in one of a plurality of configurations, including the first rotational configuration and the second rotational configuration. When the spin locking mechanism is engaged, rotation of the seat attachment 60 about the axis of rotation X is restricted. It should be appreciated that the spin locking mechanism may be operable to lock the seat attachment 60, and therefore a child seat coupled thereto, at only the first and second configurations, or alternatively, at any suitable position along the path of rotation between the first rotational configuration and the second rotational configuration.

A spin release actuator 100 may be operable to selectively disengage the spin locking mechanism and therefore allow rotation of the seat attachment 60 about the axis X. In an embodiment, at least a portion of the spin release actuator 100 is located at the child seat connectable to the seat attachment 60 (see FIGS. 13A-13B). However, embodiments where all or at least a portion of the spin release actuator 100 is mounted locally about the support base 20 are also contemplated herein.

In an embodiment, the incline member 42 is movable, for example translatable, relative to the base body 22 between a first position, such as a reclined position, and a second position, such as an inclined position. However, it should be appreciated that the first position and the second position may both be positions arranged at an incline, the positions having varying degrees of incline. In the illustrated, non-limiting embodiment, the connecting member 54 of the incline member 42 is arranged generally adjacent to or flush with the upper end 101 of the back portion 26 of the base body 22 when in the first position. Similarly, when in the second position, the incline member 42 protrudes through an opening 103 formed at the upper end 101 of the back portion 26 such that the connecting member 54 is spaced from the end of the back portion 26 by a distance.

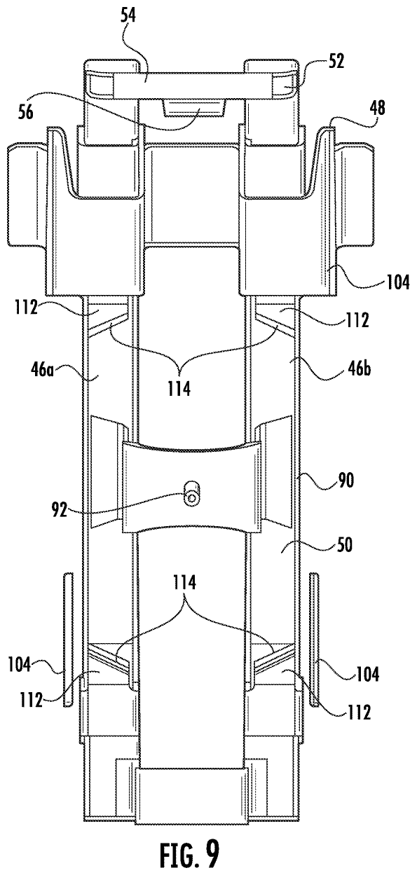

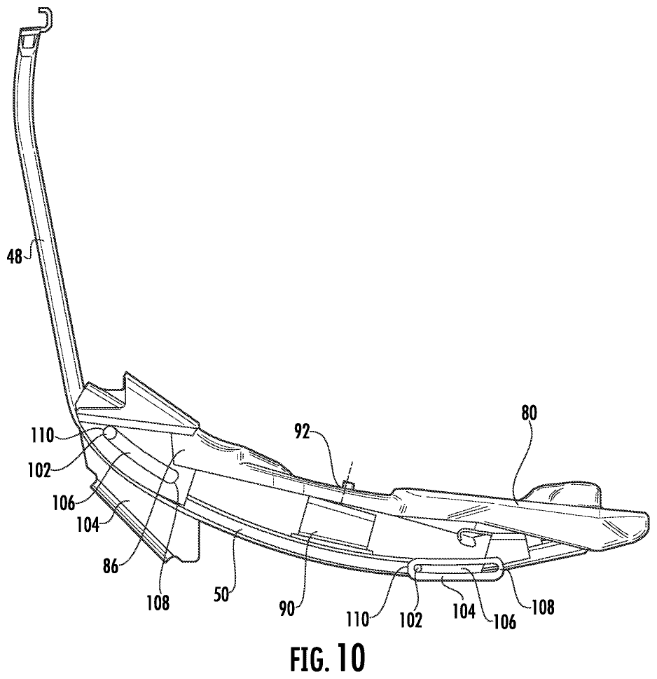

With reference to FIGS. 9 and 10, in the illustrated, non-limiting embodiment, at least one of the first leg 46a and the second leg 46b of the incline member 42 has one or more pins 102 protruding outwardly therefrom. Although two pins 102 (FIG. 10) are shown protruding from each leg 46a, 46b, it should be appreciated that embodiments having only a single pin or more than two pins are also within the scope of the disclosure. Further, although each of the pins 102 is illustrated as being arranged at the lower portion 50 of each leg 46a, 46b, in other embodiments, one or all of the pins 102 may extend from the upper portion 48 of the legs 46a, 46b.

A plurality of movement brackets 104 are arranged within the interior 44 of the base body 22, such as adjacent to a surface of at least one of the legs 46a, 46b. Although the brackets 104 are illustrated as separate components positioned within the interior 44 of the base body 22, it should be appreciated that the embodiments where the movement brackets 104 are integrally formed with the base body 22 are also contemplated herein. Each of the movement brackets 104 has at least one elongated slot 106 formed therein, and a corresponding pin 102 of the incline member 42 is receivable within each slot 106. The position of the pin 102 within the slot 106 allows a force applied by the vehicle belt 12 to the base body 22 to be directly transferred to the incline member 42. The slots 106 define a path of movement of the incline member 42 relative to the base body 22. Accordingly, in the illustrated, non-limiting embodiment, the incline member 42 is in the first or reclined position when the pins 102 are positioned adjacent to a first end 108 of each of the slots 106, and the incline member 42 is in the second or inclined position when the pins 102 are positioned adjacent to a second, opposite end 110 of each of the slots 106.

It should be understood that the pin and slot engagement described herein is intended as an example only and that any configuration that allows movement of the seat receiving assembly 40 relative to the base body 22 is within the scope of the disclosure. For example, in an embodiment, the legs 46a, 46b of the incline member 42 have one or more rollers configured to engage a curved surface of the base body 22 or of a component arranged within the interior 44 of the base body 22.

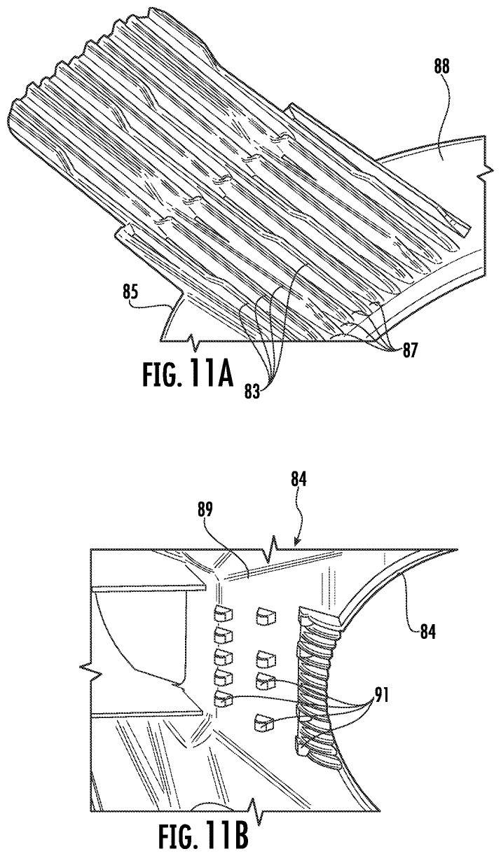

With reference to FIGS. 11A-12B, an alternative or additional connection between the seat receiving assembly 40 and the base body 22 is illustrated. As shown, at least one rib 83, such as a plurality of ribs for example, protrudes upwardly from the upper surface of the fin 88 of the support plate 80. The ribs 83 may but need not extend beyond the end 85 of the support plate 80. In addition, the configuration of the ribs 83 may be substantially identical or may vary. In the illustrated, non-limiting embodiment, the plurality of ribs 83 are spaced apart from one another to define a slot 87 between adjacent ribs 83. As best shown in FIGS. 11B, an inner surface 89 of the base body 22, facing toward the fin 88 includes one or more projections 91 slidably receivable within the one or more slots 87 defined by the ribs 83. In embodiments including a plurality of projections 91, the projections 91 may be substantially identical, or may vary. Further, the projections 91 may be axially spaced over the inner surface 89 in one or more directions such that two or more projections 91 may be receivable within the same slot 87. However, in other embodiments, both the upper surface of the fin 88 and the corresponding inner surface 89 of the base body 22 may be substantially smooth. In such embodiments, the upper surface of the fin 88 may be separated from the inner surface 89 of the base body 22 by a gap or clearance such that the support plate 80 is freely movable with the incline member 42 relative to the base body 22.

With reference to FIGS. 12A and 12B, as the incline member 42, and therefore the support plate 80 and seat attachment 60, translate between the first position (FIG. 12A) and the second position (FIG. 12B), the at least one projection 91 remains arranged within a corresponding slot 87, thereby limiting lateral movement of the seat receiving assembly 40. In addition, this engagement between the at least one slot 87 and projection 91 allows the vehicle belt force to be transferred directly to the seat receiving assembly 40 by the base body 22.

Further, it should be appreciated that because the seat attachment 60 is coupled to the incline member 42 via the mounting post 92, the seat attachment 60 and a child seat affixed to the seat attachment 60 are movable with the incline member 42 relative to the support base 20.

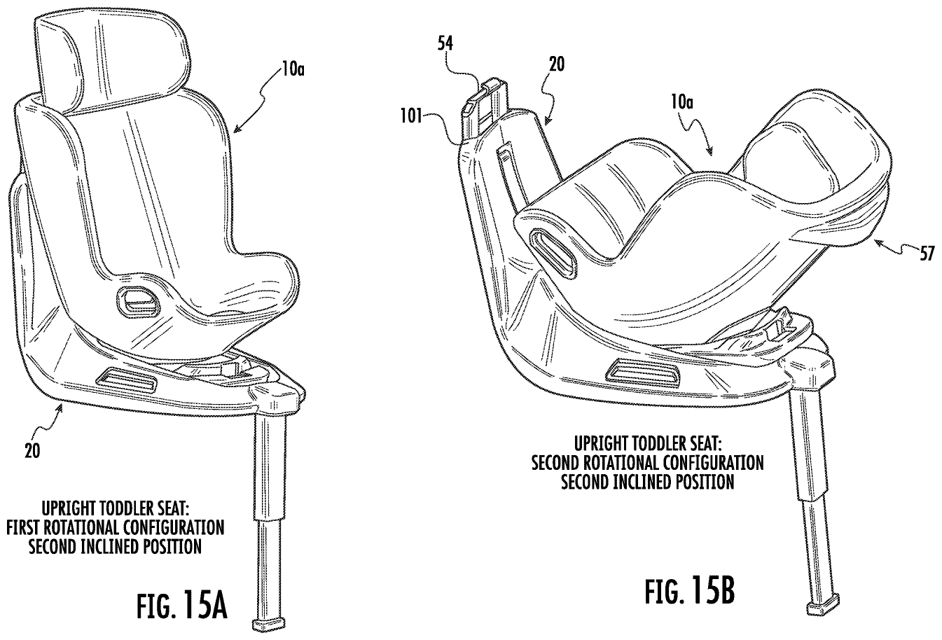

The incline member 42 is transformable between the first position (FIGS. 13A, 13B, 14A, and 14B) and the second position (FIGS. 15A, 15B, 16A, and 16B) regardless of the rotational position of the seat attachment 60 relative to the base body 22 and the incline member 42. For example, the incline member 42 may be movable when the seat attachment 60 is at any location of the 360 degrees of rotation of the seat attachment 60. Similarly, the seat attachment 60 may be rotatable about the axis X regardless of the position of the incline member 42 relative to the base body 22. As shown, either child seat 10a, 10b can be inclined when in both the first forward-facing configuration, the second rearward-facing configuration, and any position therebetween. Further, because the incline member 42 is located within the interior 44 of the base body 22 and is separate from the belt tensioner 35 and the belt receiving path, the incline member 42 is moveable between the first and second positions without impacting a position of the vehicle belt on the belt receiving path and without affecting the tension applied to the vehicle belt by the belt tensioner 35.

In the illustrated, non-limiting embodiment best shown in FIG. 9, the incline member 42 includes a plurality of incline retention members 112, for example in vertically overlapping arrangement with the lower portion 50 of the legs 46a, 46b, respectively. The ends 114 of the incline retention members 112 positioned closest to the mounting bracket 90 may have a contour complementary to the periphery of the collar 72 or flanges 74, 78. Although each incline retention member 112 is illustrated as a distinct component, embodiments where each of the ends 114 thereof cooperate or are coupled to define a ring that extends about a substantial entirety of the periphery of the collar or flanges 74, 78 is also within the scope of the disclosure.

As the incline member 42 is transformed from a first or reclined position to a second or inclined position, the ends 114 of the incline retention members 112 arranged at a first side of the collar 72 are configured to engage a portion of the flange 74, 78 of the seat attachment 60 to prevent transverse movement of the seat attachment 60. Similarly, as the incline member 42 is transformed from an inclined position to a reclined position, the ends 114 of the incline retention members 112 arranged at a second side of the collar 72 are configured to engage a portion of the flange 74, 78 of the seat attachment 60 to prevent transverse movement of the seat attachment 60. For example, in embodiments where the seat attachment 60 is arranged in one of a forward-facing configuration or a rearward-facing configuration, the incline retention members 112 are configured to engage the at least one flange 78 of the attachment member 64 to restrict unwanted movement of the seat attachment 60. However, embodiments where the one or more of the incline retention members 112 are alternatively or additionally configured to engage a flange 74 of the collar 72 when the seat attachment 60 is in one of a forward-facing configuration or a rearward facing configuration are also contemplated herein. It should also be appreciated that the incline retention members 112 may be configured to contact one or both flanges 74, 78 based on the relative position of the seat attachment 60.

Further, because the opening 82 of the support plate 80 is substantially identical in size to the diameter of the collar 72, in some embodiments, the movement of the seat attachment 60 resulting from movement of the incline member 42 may cause a similar movement of the support plate 80 relative to the base body 22. However, by forming the support plate 80 with dimensions greater than the opening 84 formed in the base body 22, the opening 84 remains covered regardless of the position of the support plate 80.

Although not shown, an incline locking mechanism is associated with the incline member 42 and is operable to selectively lock the incline member 42 in one of a plurality of configurations, including the first reclined configuration and the second inclined configuration. When the incline locking mechanism is engaged, movement of the incline member 42 relative to the support base 20 is restricted. It should be appreciated that the incline locking mechanism may be operable to lock the incline member 42 in only one of the reclined position and the inclined position. However, in other embodiments, the incline locking mechanism may be configured to lock the incline member 42 at any suitable position along the path of movement between the reclined position and the inclined position to achieve varying degrees of incline of the seat attachment 60. In an embodiment, an incline release actuator is operable to selectively disengage the incline locking mechanism, thereby allowing movement of the incline member 42 relative to the support base 20. Although an input 116 associated with operation of the incline release actuator is illustrated as being arranged at the support plate 80, near the second end of the seat portion 24 of the base body 22 for example, in other embodiments, the input may be located at another location about the support base 20.

The support base 20 as described herein provides the benefit of being suitable for use with multiple interchangeable child seats, such that the same base may be used with different seats as a child grows. Further, the support base 20 allows the rotational configuration and the incline of each child seat to be adjusted relative to the base body 22 and the vehicle seat.

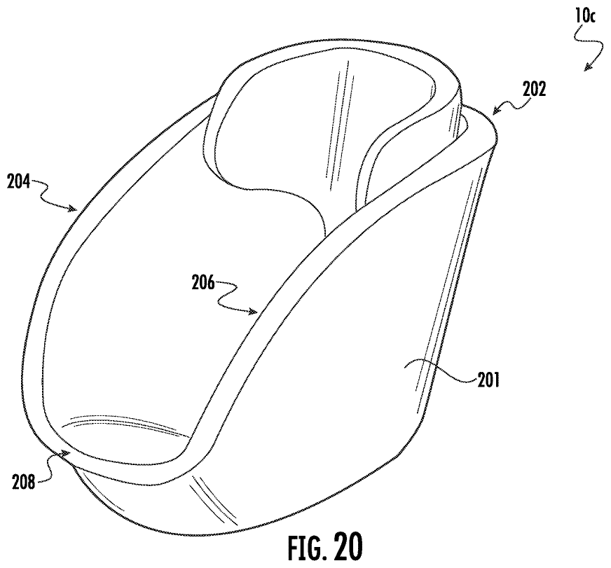

FIGS. 20-30B illustrate alternate aspects of toddler seats 10c-10g, according to aspects of this disclosure. It should be understood that portions of the alternate aspects of the toddler seats 10c-10g disclosed in FIGS. 20-30B are similar to aspects of the toddler seat 10a described above in FIGS. 13A-13B, 15A-15B, and 19, and those portions function similarly to those described above.

With reference to FIG. 20, the toddler seat 10c includes a body 201 having a back portion 202 and two side portions 204 and 206 extending forward from the back portion 202. The two side portions 204 and 206 each define an upper edge of the body 201 that extends from the back portion 202 toward a front end 208 of the seat 10c. Each of the upper edges can define a convex shape. In an aspect, the convex shape of the upper edges can be continuous from the back portion 202 to the front end 208 such that the upper edges are free of any notches, recesses, openings or other shapes or configurations that could indicate a belt path location. The shape and configuration of the side portions 204 and 206 can help prevent misuse of the toddler seat 10c by substantially preventing a user from securing the toddler seat 10c directly on a vehicle seat using a seatbelt.

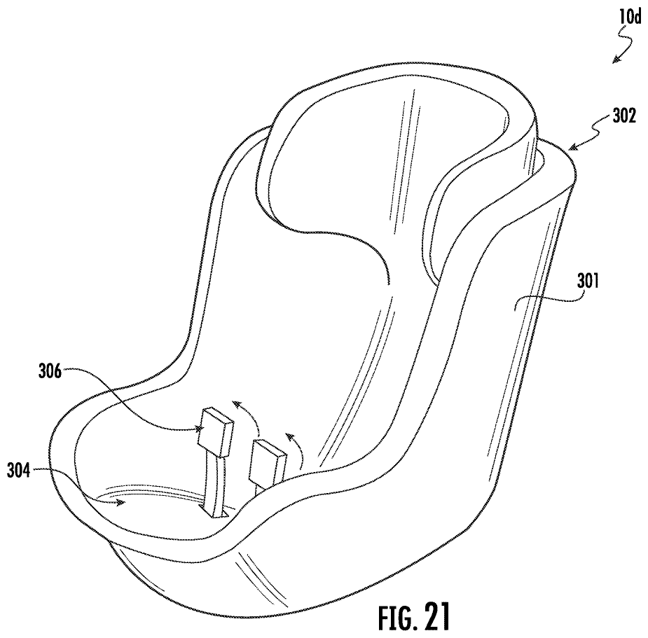

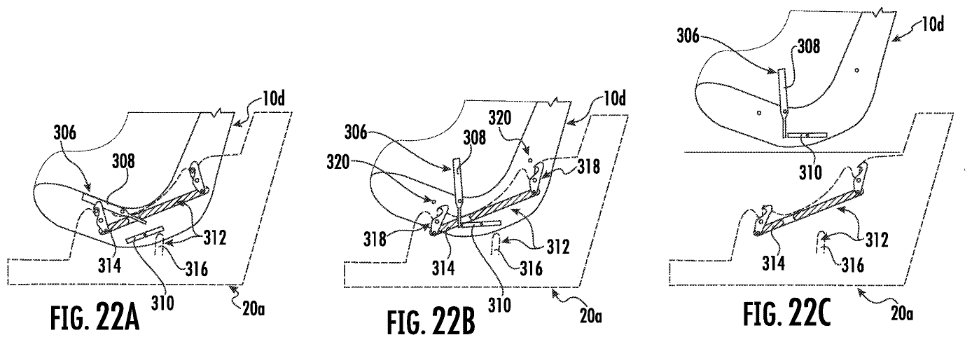

With reference to FIGS. 21 and 22A-C, a child seat system is illustrated that includes the toddler seat 10d and a support base 20a. The toddler seat 10d includes a seat body 301 having a seat portion 304 and a back portion 302 extending in an upward direction from the seat portion 304. The seat portion 304 includes a flag assembly 306 connected thereto. The flag assembly 306 can transition between an upright position and a stowed position. When the flag assembly is in the stowed position, the toddler seat 10d may be considered to be in a first configuration in which the toddler seat 10d can receive and support a child seated on the seat portion 304. When the flag assembly 306 is in the upright position (as seen in FIG. 21), the toddler seat 10d may be considered to be in a second configuration where the seat portion 304 is substantially prevented from receiving and supporting a child thereon. The toddler seat 10d may be transformable between the first configuration and the second configuration by coupling or decoupling the toddler seat 10d from a support base 20a. In an embodiment, the toddler seat is configured to transition from the second configuration to the first configuration by connecting the toddler seat 10d to the support base 20a. Although this transformation is described with respect to a toddler seat 10d, it should be appreciated that other seats connectable to the supper base 20a, such as an infant car seat for example, may also be configured to transform between a first configuration in which a child is receivable on the seat and a second configuration in which a child is not positionable on the seat.

In the illustrated, non-limiting embodiment, the flag assembly 306 includes at least one flag 308 and a flag lock 310. The at least one flag 308 is pivotally connected to the seat portion 304. The at least one flag 308 can transition between the upright position (FIG. 22B) and the stowed position (FIG. 22A) by rotating relative to the seat portion 304. In an aspect, the at least one flag 308 is biased toward the stowed position. For example, a biasing member (not shown) can be connected to the at least one flag 308 to bias the at least one flag 308 toward the stowed position. The seat portion 304 can define an opening through which the at least one flag 308 extends when the flag 308 is in the upright position. The flag lock 310 is pivotally connected to the seat portion 304. The flag lock 310 can rotate between a locked position (FIG. 22B) and an unlocked position (FIG. 22A. In the locked position, the flag lock 310 can substantially prevent the at least one flag 308 from transitioning from the upright position to the stowed position. In the unlocked position, the at least one flag 308 is free to rotate from the upright position to the stowed position. In an aspect, the flag lock 310 is biased toward the locked position.

The support base 20a includes a flag actuation assembly 312. The flag actuation assembly 312 is configured to transition the flag assembly 306 between the upright position and the stowed position. The flag actuation assembly 312 includes a release member 314 and an unlock member 316. The release member 314 can be connected to a set of latches 318. Each latch 318 can be configured to engage a corresponding catch 320 on the toddler seat 10d to lock the toddler seat 10d to the support base 20a. The release member 314 is configured to operatively connect with the at least one flag 306 when the toddler seat 10d is positioned on the support base 20a. For example, the release member 314 can define an opening through which the at least one flag 306 extends through. When the at least one flag 306 transitions between the upright position and the stowed position, the release member 314 and the latches 318 can transition between an unlatched position (FIG. 22B) and a latched position (FIG. 22A), respectively. In an aspect, the release member 314 is slidable connected to the support base 20a, such that the release member 314 translates between the unlatched position and the latched position.

The unlock member 316 can be connected to the support base 20a. The unlock member 316 is positioned to engage the flag lock 310 to transition the flag lock 310 from the locked position to the unlocked position when the toddler seat 10d is positioned on the support base 20a. In an aspect, the unlock member 316 is rigidly connected to the support base 20a.

During operation, when the toddler seat 10d is placed on the support base 20a and the latches 318 are engaged with the catches 320, as illustrated in FIG. 22A, the toddler seat 10d is secured to the support base 20a, the flags 308 are in the stowed position, the flag lock 310 is in the unlock position, and the release member 314 is in the latched position. To release the toddler seat 10d, the latches are actuated to transition from the latched position to the unlatched position, which causes the release member 314 to transition the flags 308 from the stowed position to the upright position. When the toddler seat 10d is removed from the support base 20a, the unlock member 316 releases the flag lock 310, which locks the flags 308 in the upright position. The flags 308 remain in the upright position until the toddler seat 10d is re-connected to the support base 20a. In the upright position, the seat portion 304 is substantially prevented from receiving and supporting a child thereon, thereby preventing improper use of the toddler seat 10d by placing the toddler seat 10d on the vehicle seat 2 without the support base 20a. It will be appreciated that other assemblies, either in addition or alternatively to the flag assembly 306, can be included on the toddler seat 10d to distort a seating surface of the seat portion 304 to prevent the toddler seat 10d from supporting a child when the toddler seat 10d is removed from the support base 20a.

When the toddler seat 10d is re-positioned on the support base 20a, the unlock member 316 transitions the flag lock 310 from the locked position to the unlocked position. When the flag lock 310 is in the unlocked position, the flags 308 are free to transition to the stowed position. When the flags 308 are in the stowed position, the seat portion 304 can receive and support a child thereon.

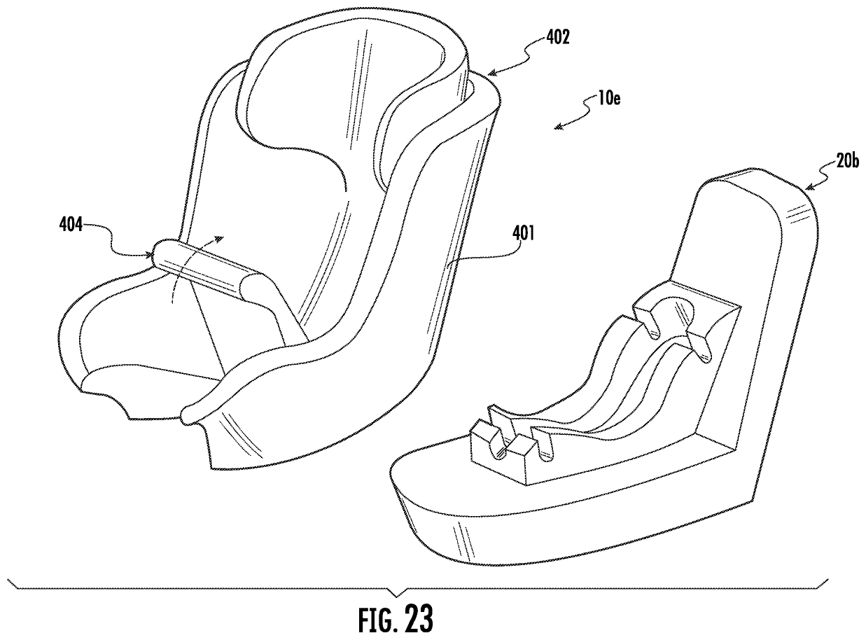

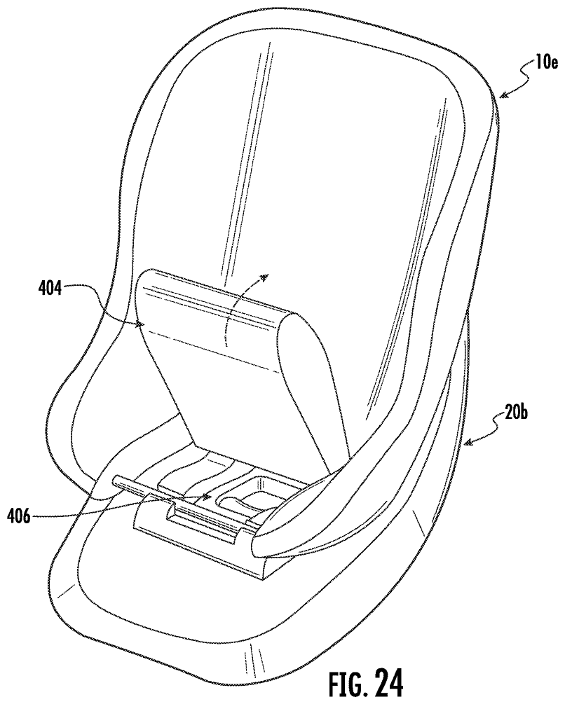

With reference to FIGS. 23 and 24, a child seat system is illustrated that includes a toddler seat 10e and a support base 20b. The toddler seat 10e includes a body 401 having a seat portion 404 and a back portion 402 extending in an upward direction from the seat portion 404. The seat portion 404 is pivotally connected with the body 401 such that the seat portion 404 can rotate relative to the back portion 402. The seat portion 404 can rotate between an upright position and a seating position. In the upright position (as seen in FIGS. 23 and 24), the seat portion 404 is substantially prevented from receiving and supporting a child thereon. In the seating position, the toddler seat 10e can receive and support a child seated on the seat portion 404.

The support base 20b can include a release actuator 406. The release actuator 406 is configured to release the toddler seat 10e from the support base 20b so the toddler seat 10e can be removed from the support base 20b. The release actuator 406 can be positioned on the support base 20b at a location underneath the seat portion 404 when the toddler seat 10e is connected to the support base 20b. To access the release actuator 406, the seat portion 404 is rotated to the upright position. In an aspect, after the seat portion 404 is rotated to the upright position and the release actuator 406 is actuated to release the toddler seat 10e, the seat portion 404 is locked in the upright position. When the seat portion 404 is locked in the upright position, the toddler seat 10e is substantially prevented from receiving and supporting a child thereon. To transition the seat portion 404 to the seating position, the toddler seat 10e is re-connected to the support base 10b. After reconnection, the lock on the seat portion 404 is released, and the seat portion 404 can transition to the seating position.

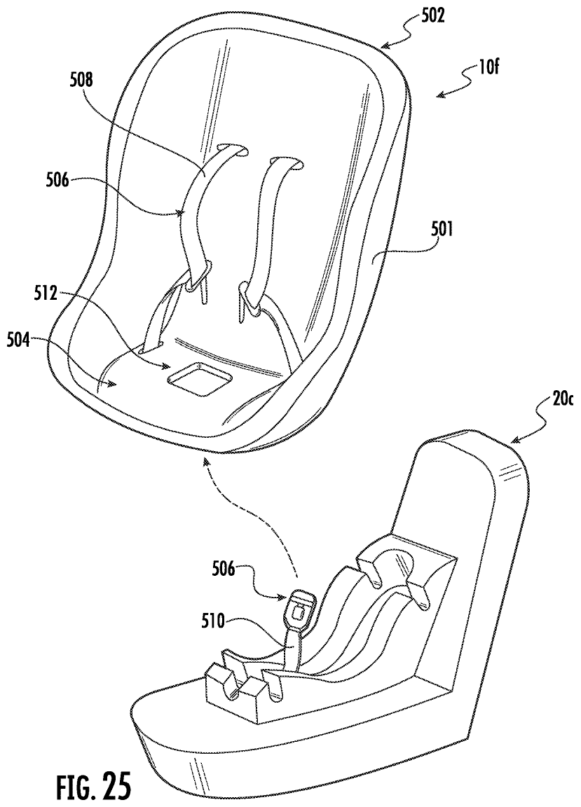

With reference to FIGS. 25-27, a child seat system is illustrated that includes a toddler seat 10f and a support base 20c. The toddler seat 10f includes a body 501 having a seat portion 504 and a back portion 502 extending in an upward direction from the seat portion 504. The child seat system further includes a harness assembly 506. The harness assembly 506 is configured to secure a child to the toddler seat 10f when the child is placed on and supported by the seat portion 504.

The harness assembly 506 includes an upper harness portion 508 and a lower harness portion 510. In an aspect, the harness assembly 506 comprises a five-point harness assembly, and the lower harness portion 510 comprises a crotch belt. The upper harness portion 508 can be connected to the back portion 502 of the toddler seat 10f. The lower harness portion 510 can be connected to the support base 20c. The lower harness portion 510 can be positioned on the support base 20c at a location underneath the seat portion 504 when the toddler seat 10f is connect to the support base 20c. The seat portion 504 defines an opening 512 through which the lower harness portion 510 can extend. When the toddler seat 10f is connected to the support base 20c, the lower harness portion 510 extends through the opening 512 to connect with the upper harness portion 508 to retain a child on the seat portion 504. When the toddler seat 10f is removed from the support base 20c, the lower harness portion 510 is not connectable with the upper harness portion 508 to retain the child on the seat portion 504. When the toddler seat 10f is not connected to the support base 20c, the harness assembly 506 is disabled.

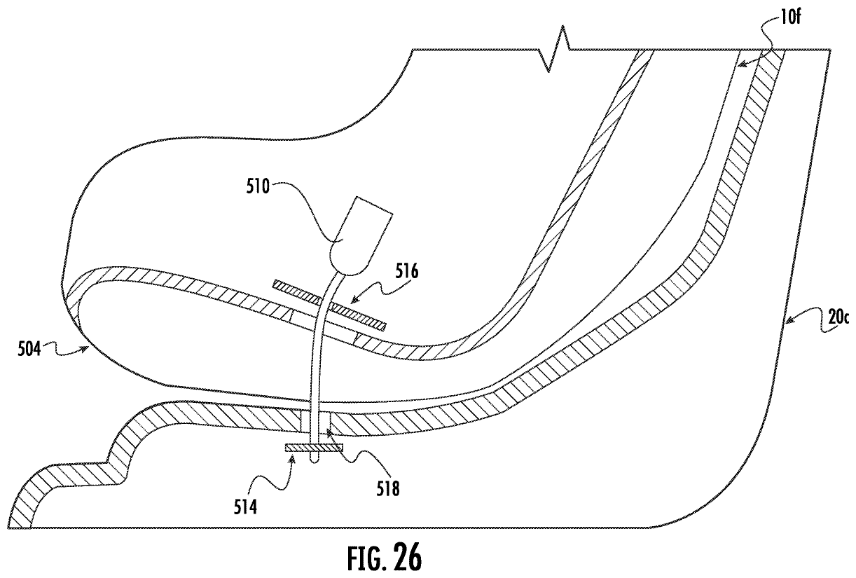

In an alternative aspect, the lower harness portion 510 can be removable from the support base 20c. With reference to FIG. 26, the support base 20c includes a base plate 514, and the seat portion 504 includes a seat plate 516. When the toddler seat 10f is connected to the support base 20c, the base plate 514 retains the lower harness portion 510 on the support base 20c, and the seat plate 516 retains the lower harness portion 510 on the toddler seat 10f. To remove the lower harness portion 510 from the support base 20c, the base plate 514 can be removed from the lower harness portion 510, and the lower harness portion 510 can be fed through an opening 518 in the support base 20c. After the lower harness portion 510 is removed from the support base 20c, the toddler seat 10f can be removed from the support base 20c. When the lower harness assembly 510 is removed from the support base 20c, the lower harness assembly 510 is unable to be an anchor point for the harness assembly 506. Since the lower harness assembly 510 is unable to be an anchor point when the toddler seat 10f is removed from the support base 10c, a user is substantially prevented from incorrectly installing the toddler seat 10f directly onto a vehicle seat without using the support base 10c.

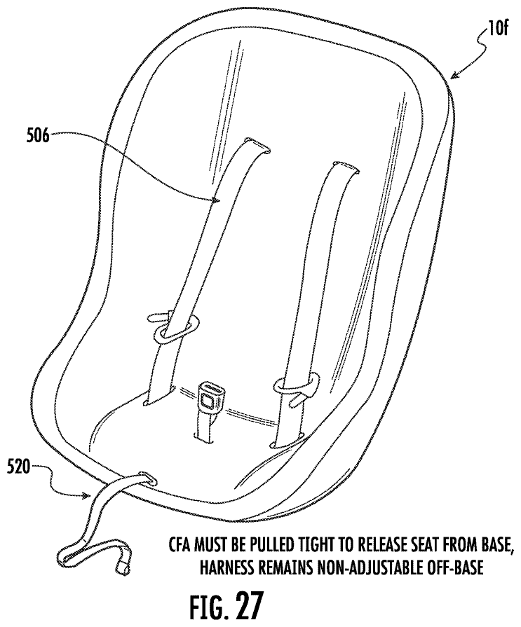

With reference to FIG. 27, in another alternative aspect, the toddler seat 10f can include a central front adjuster (CFA) 520 operably connected to the upper harness assembly 506. The CFA 520 and the upper harness assembly 506 can be configured such that in order to remove the toddler seat 10f from the support base 20c the CFA 520 must be pulled to a predetermined tension. After the toddler seat 10f is removed, the CFA 520 is locked at the predetermined tension, rendering the harness assembly 506 unusable. To unlock the CFA 520, the toddler seat 10f can be re-connected to the support base 20c. It will be appreciated that the predetermined tension can be defined as a tension in the harness assembly 506 that substantially prevents the harness assembly 506 from being positioned about and/or retaining a child positioned on the seat portion 504 of the toddler seat 10f.

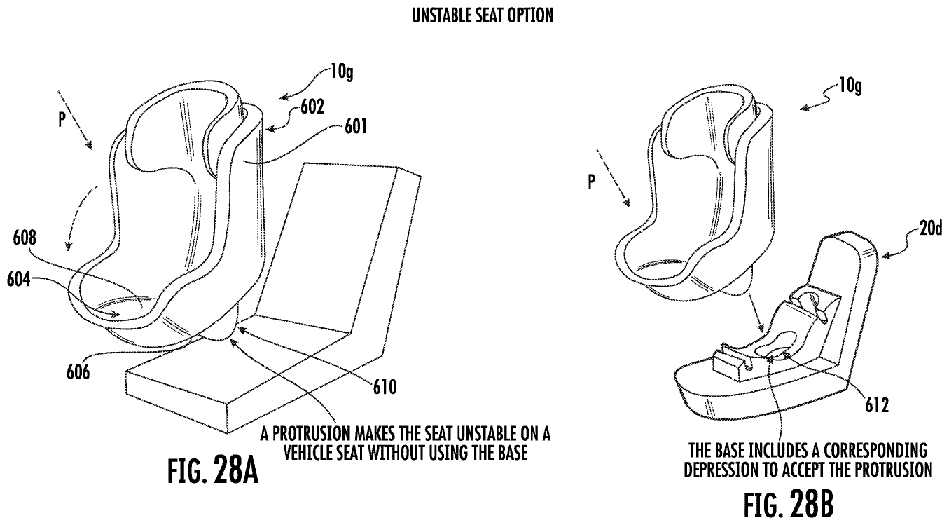

With reference to FIGS. 28A and 28B, a child seat system is illustrated that includes a toddler seat 10g and a support base 20d. The toddler seat 10g includes a body 601 having a seat portion 604 and a back portion 602 extending in an upward direction from the seat portion 604. The seat portion 604 has a bottom seat surface 606 and an opposing upper seat surface 608 configured to support a child on the toddler seat 10g. The bottom surface 606 can have a shape that causes the toddler seat 10g to be unstable (e.g., not upright, or sideways) when the toddler seat 10g is positioned directly on a vehicle seat. For example, the bottom seat surface 606 can define a protrusion 610 that makes it difficult to position the toddler seat 10g in an upright position when the toddler seat 10g is positioned directly on a vehicle seat. The support base 20d can include a depression 612 that corresponds to the protrusion 610, such that when the toddler seat 10g is positioned on the support base 20d, the protrusion 610 is positioned within the depression 612 and the toddler seat 10g is positioned upright on the support base 20d.

The protrusion 610 can define a “point load,” such that when the toddler seat 10g is place directly on a vehicle seat, only the protrusion 610 contacts the vehicle seat making the toddler seat 10g unstable (e.g., tending to fall to a side). In an aspect, the protrusion 610 is the only portion of the bottom surface 606 that contacts the vehicle seat when the toddler seat 10g is placed directly on the vehicle seat. The “point load” can be defined as a point, edge, or surface of the bottom surface 606 that comprises less than approximately 10% of the entire bottom surface. In an aspect the “point load” can comprise less than approximately 5% of the bottom surface 606. In another aspect, the “point load” can comprise less than approximately 1% of the bottom surface 606.

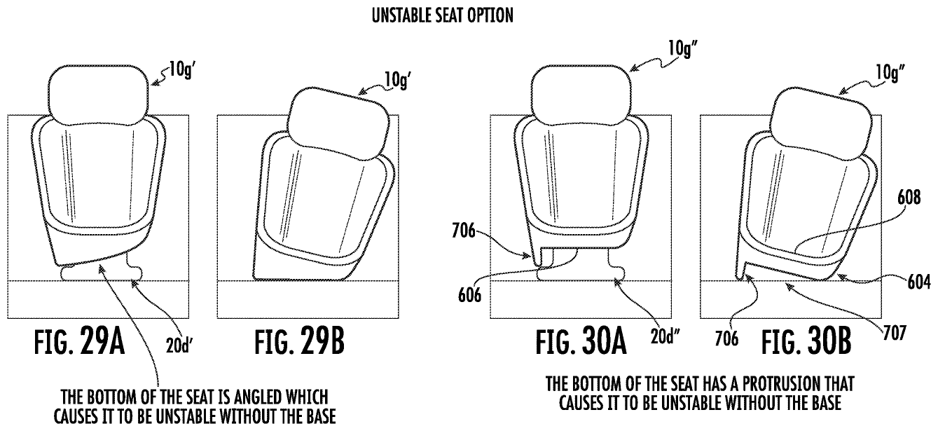

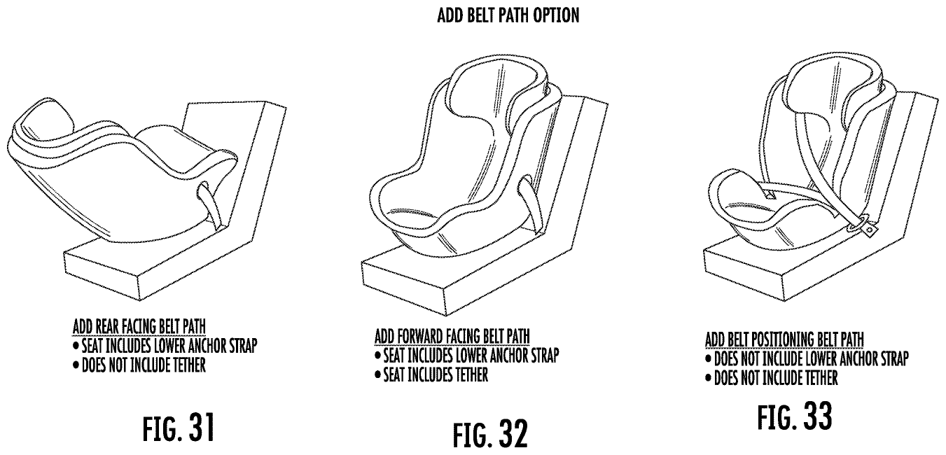

FIGS. 29A-29B and 30A-30B illustrate alternative aspects for the bottom seat surface 606 of the seat portion 604. In each aspect, the seat portion 604 causes the toddler seat 10g′, 10g″ to be unstable without the respective support base 20d′, 20d″. When the toddler seat 10g′, 10g″ is positioned on the respective support base 20d′ 20d″, the toddler seat 10g′, 10g″ is positioned upright. The toddler seat 10g″ includes a protrusion or leg 706 positioned at an off-center location on the bottom surface 606. When the toddler seat 10g″ is positioned on a vehicle seat without the support base 20d″, the toddler seat 10g″ sits sideways at an angle (see FIG. 30B). It will be appreciated that the toddler seat 10g″ can include more than one protrusion 706. For example, the protrusions 706 on the bottom surface 606 can have different heights creating a contact plane 707 on the bottom of the seat portion 604 that is angularly offset from the upper seat surface 608 on the seat portion 604. The angular offset of the upper seat surface 608 can render the toddler seat 10g′, 10g″ unstable, and therefore, unusable.

During installation, the toddler seat 10g is connected to the support base 20d by lowering the toddler seat 10g on top of the support base 20d in a placement direction P, which orients the upper seat surface 608 at a first angle orientation. If the toddler seat 10g is removed from the support base 20d and positioned directly on a vehicle seat by lowering the toddler seat 10g on top of the vehicle seat in the placement direction P, the contact between the bottom seat surface 606 and the vehicle seat causes the toddler seat 10g to be unstable and the upper seat surface 608 to be oriented at a second angle orientation. The second angle orientation is different than the first angle orientation. Stated another way, when the toddler seat 10g is positioned directly on the vehicle seat, the shape of the bottom seat surface 606 causes the toddler seat to be oriented at the second angle orientation.

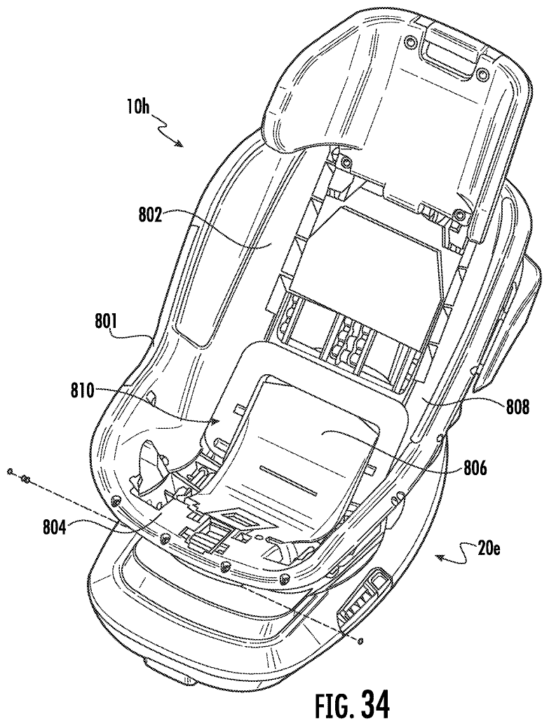

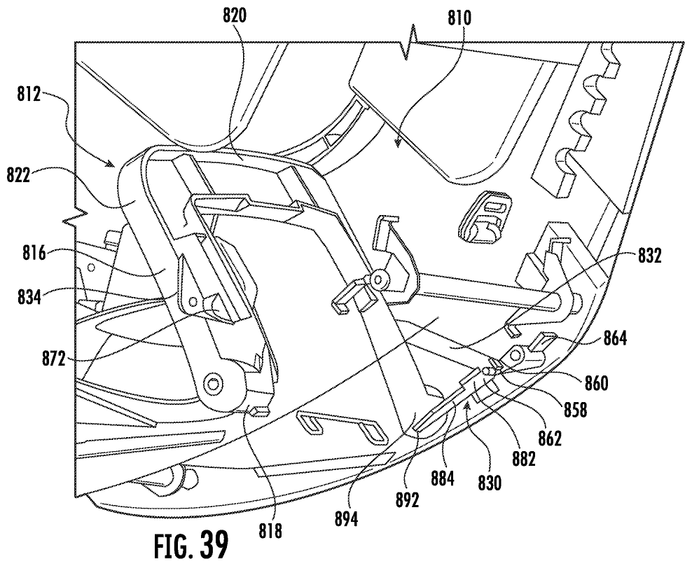

With reference to FIGS. 34-45, the illustrated child seat system 20 similarly includes a toddler seat 10h and a support base 20e. The toddler seat 10h includes a seat body 801 having a seat portion 804 and a back portion 802 extending in an upward direction from the seat portion 804. The toddler seat 10h has a seating area 806 sized to support a child therein. The seating area 806 may be defined by the back portion 802, the seat portion 804, or a combination of both the back portion 802 and the seat portion 804. In an embodiment, an inner seat surface 808 defines a portion of the seating area 806. The inner seat surface 808 may be located at a surface of the back portion 802, the seat portion 804, or a combination of both the back portion 802 and the seat portion 804.

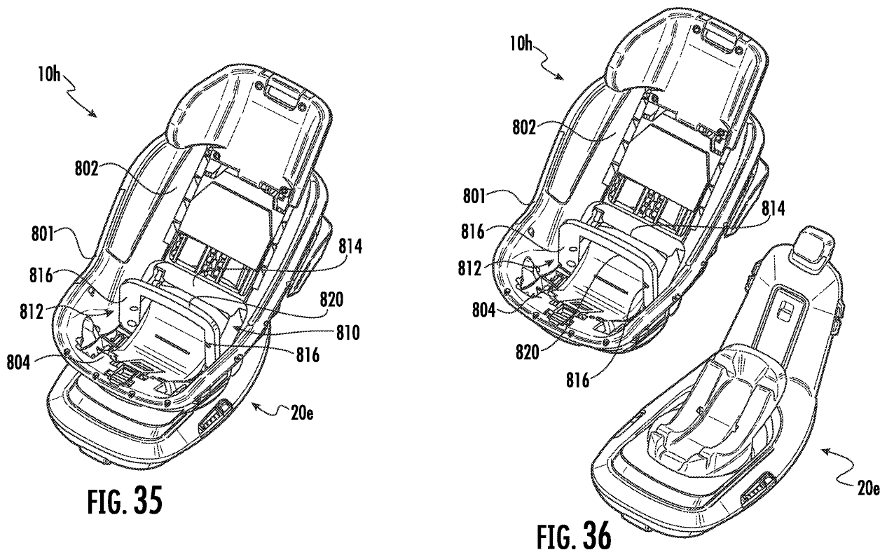

The seat portion 804 may include a disablement assembly 810 connected thereto. The disablement assembly 810 can transition between a first or upright position (FIG. 35) and a second or stowed position (FIG. 34). In the upright position, the seat portion 804 is substantially prevented from receiving and supporting a child thereon. In the stowed position, the toddler seat 10h can receive and support a child seated on the seat portion 804. In some embodiments, the toddler seat 10h may be prevented from being detached from the support base 20e when the toddler seat 10h is in the first configuration, and the toddler seat 10h may be free to be detached from the support base 20a when the toddler seat 10h is in the second configuration.

The disablement assembly 810 includes a block member 812. The block member 812 may be pivotally or rotatably coupled to a portion of the seat body 801, such as the seat portion 804 for example. However, embodiments where the block member 812 is coupled to another portion of the seat body 801, such as the back portion 802, are also within the scope of the disclosure as long as the block member 812 interferes with and prevents a child from sitting on the seat portion 804. In the illustrated, non-limiting embodiment, when in the upright position, the block member 812 protrudes upwardly from the seat portion 804 of the seat body 801. When the disablement assembly 810 or the block member 812 thereof is in the stowed position, the toddler seat 10h may be considered to be in a first configuration in which the toddler seat 10h can receive and support a child seated on the seat portion 804. When the disablement assembly 810 or the block member 812 thereof is in the upright position, the toddler seat 10h may be considered to be in a second configuration where the seat portion 304 is substantially prevented from receiving and supporting a child thereon.

In the upright configuration, the block member 812 may extend at least partially into the seating area. In the stowed position, the block member 812 is seated within a recess 814 formed in an adjacent portion of the seat body 801. In the stowed position, the block member may be positioned outside of the seating area. When arranged within the recess 814, the block member 812 may be generally flush with the adjacent portion of the seat body 801. Although the recess 814 is shown as being formed at the back portion 802, such as near the interface with the seat portion 804 for example, embodiments where the recess 814 is alternatively or additionally formed in the seat portion 804 are also contemplated herein.

In the illustrated, non-limiting embodiment, the block member 812 is generally U-shaped. As shown, the block member 812 includes two legs 816 connected at opposing ends 818 thereof, also referred to herein as first ends, to the seat body 801, such as to the seat portion 804 for example. A handle 820 portion may be positioned between and connected to the second ends 822 of the two legs 816. By providing a U-shaped block member 812, when the block member 812 is in the upright configuration, the handle portion 822 is easily accessible by a user such as to lift the seat 10h for example. It should be appreciated that the block member 812 illustrated and described herein is intended as an example only and that a block member having any suitable configuration is within the scope of the disclosure

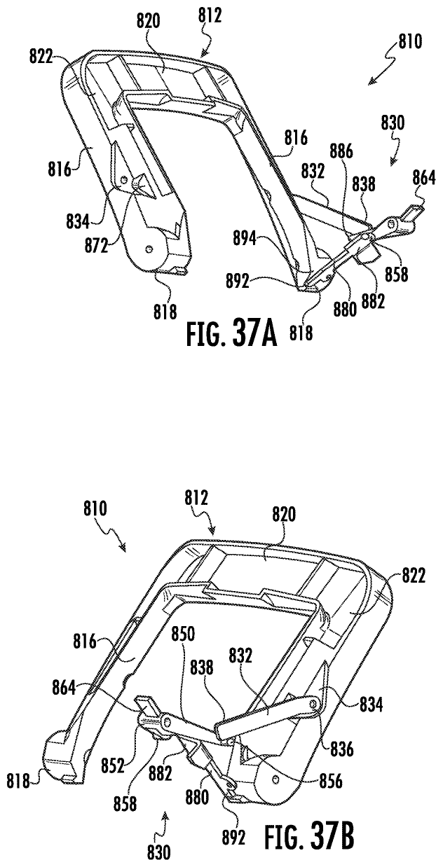

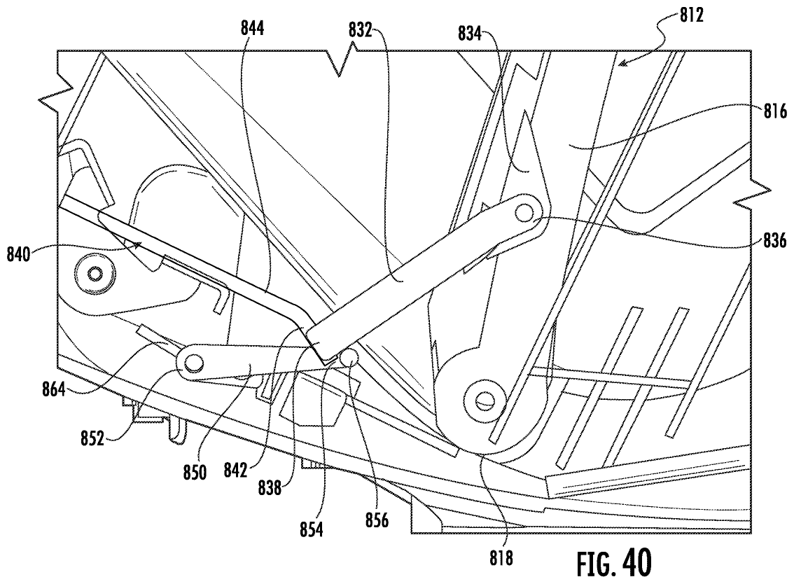

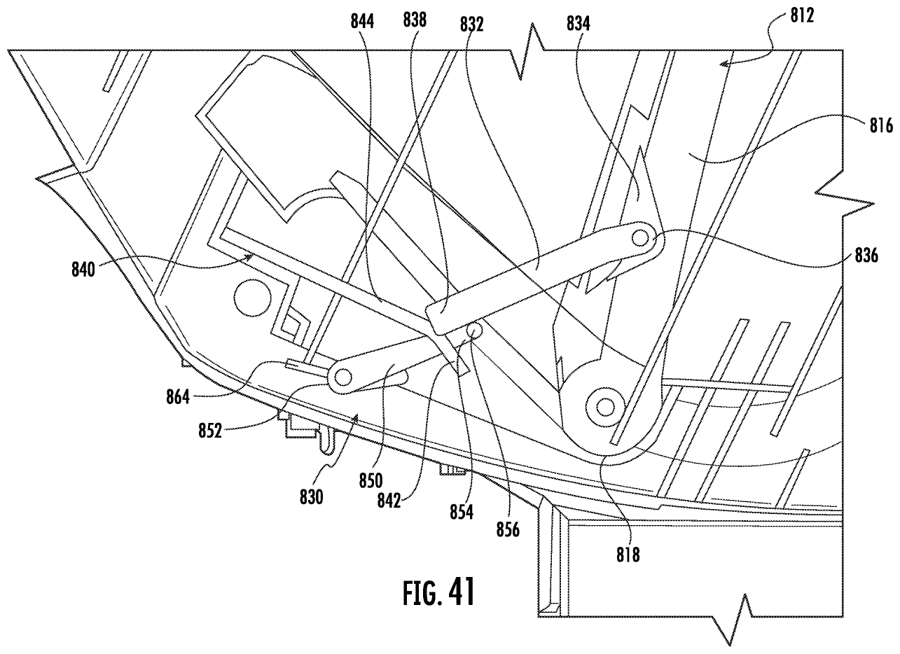

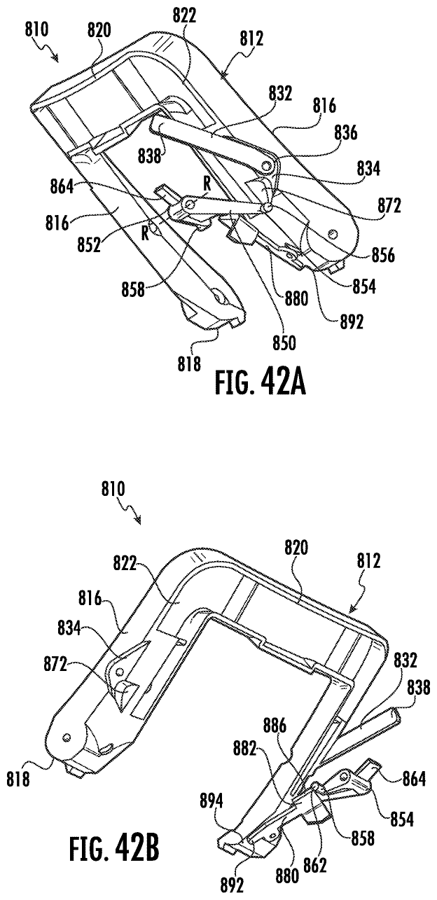

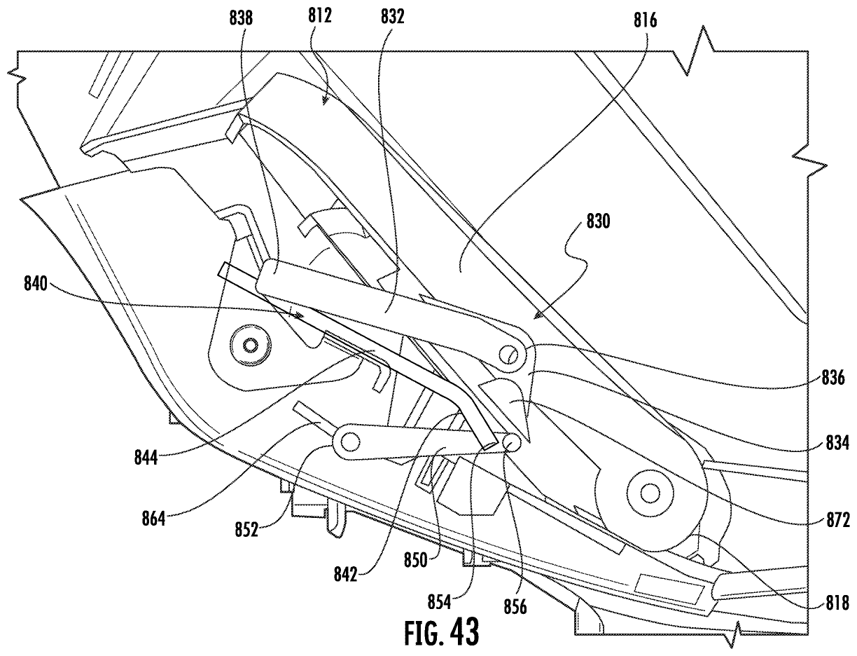

The disablement assembly 810 additionally includes an actuation assembly 830 associated with and operably coupled to the block member 812. In the illustrated, non-limiting embodiment, the actuation assembly 830 includes a first lock 832, also referred to herein as a block member lock. The block member lock 832 is operable to lock the block member 812 in the upright position. The block member lock 832 has an elongated body and may be movably connected to the block member 812. As shown, a first lock groove 834 may be formed at a side of the block member 812, such as at a first leg 816 thereof, and a first end 836 of the block member lock 832 may be positioned therein. In an embodiment, the first end 836 of the block member lock 832 is pivotally connected to the block member 812 such that the block member lock 832 is rotatable about an axis relative to the block member 812. The block member lock 832 may be rotatable about its axis between a first or locked position (FIGS. 37A, 37B, and 40) associated with the disablement assembly 810 in the upright position and a second position (FIGS. 42A, 42B, and 43) associated with the disablement assembly 810 in the stowed position.

When the block member lock 832 is in the locked position, such as when the seat 10h is detached from the support base 20e, the block member 812 is substantially prevented from moving relative to the seat 10h. A biasing mechanism (not shown), such as a coil spring or torsion spring for example, may be operably coupled to the block member lock 832. In such embodiments, the biasing mechanism may bias the block member lock 832 toward the first position.

A block member lock track 840 is arranged within the seat body 801 near the distal, second end 838 of the block member lock 832. In an embodiment, the block member lock track 840 may be integrally formed with a surface of the seat body 801. The block member lock 832 may be arranged in contact with a portion of the block member lock track 840 when in both the first and second positions. Further, in some embodiments, the block member lock 832 may remain in contact with the block member lock track 840 as the block member lock 832 transitions between the first and second positions. In the illustrated, non-limiting embodiment, the block member lock track 840 includes a first portion 842 and a second portion 844. The second portion 844 is arranged at a non-parallel angle to the first portion 842 such that a bend is formed in the block member lock track 840. In an embodiment, the block member lock 832 is arranged in contact with the first portion 842 when in the locked position and is arranged in contact with the second portion 844 when in the stowed position. When the block member lock 832 is arranged in the first position, engagement between the block member lock 832 and first portion 842 of the block member lock track 840 restricts movement of the block member 812 toward the stowed position.

A sensor member 850 may be operably coupled to the block member 812 lock to facilitate movement of the block member lock 832 from the first position to the second, position. In an embodiment, the sensor member 850 is pivotally coupled to the seat body 801. As shown, the first end 852 of the sensor member 850 may be pivotally connected to the seat body 801 of the toddler seat 10h, and the second end 854 of the sensor member 850 may be selectively engageable with the block member lock 832. The second end 854 of the sensor member 850 may include an engagement feature 856, such as a post or other protrusion for example, arranged within a plane of movement of the block member lock 832. When the disablement assembly 810 is in the upright position, a portion of the block member lock 832, such as near the second end 838 for example, is arranged in contact with or proximate to the engagement feature 856 of the sensor member 850. In an embodiment, this engagement restricts further downward rotation of the block member lock 832 about its axis.

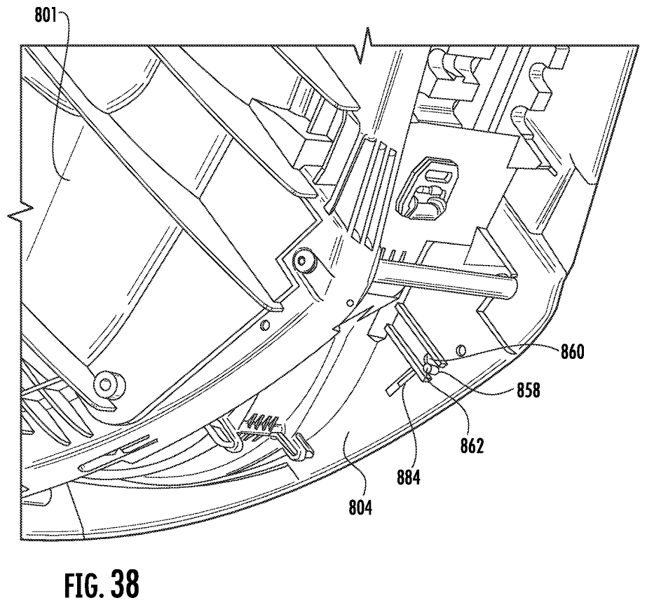

In an embodiment, the sensor member 850 includes a sensor feature 858. As shown, the sensor feature 858 is a post or protrusion that extends away from the body of the sensor member 850. Although the sensor feature 858 and the engagement feature 856 are illustrated as being arranged at opposite sides and extending in opposite directions from the body of the sensor member 850, in other embodiments the sensor feature 858 and the engagement feature 856 may be arranged at the same side of the sensor member 850. In an embodiment, as shown in FIG. 38, the sensor feature 858 extends through an opening 860 formed in the seat body 801 such that a distal end 862 of the sensor feature 858 is arranged at an exterior surface of the seat body 801, facing a surface of the support base 20e. The opening 860 may be a slot such that the sensor feature 858 is translatable within the slot. Further, the sensor member 850 may be rotatable about an axis R, such as defined at or near the first end 852. In an embodiment, the sensor member 850 additionally includes a boss 864 configured to cooperate with a biasing mechanism (not shown), such as a compression spring for example, to bias the sensor member 850 to rotate toward the locked position of the block member lock 832 and likewise move engagement feature 856 away from the block member lock 832 (e.g., in the perspective of FIGS. 40, 41, and 42A, the boss is biased upward to rotate the sensor member 850 clockwise about the axis R).

A first lock member lock release 866 is operatively connectable to the block member lock 832. The first lock member lock release 866 may be arranged at an exterior surface of the support base 20e. The first lock member lock release 866 is positioned in alignment with the sensor feature 858 as the toddler seat 10h is mounted to the support base body. In an embodiment, the first lock member lock release 866 is arranged at an exterior surface of a seat attachment 867, similar to seat attachment 60 of FIGS. 1-6. The first lock member lock release 866 has a groove or recess 868 formed therein within which the sensor feature 858 is received. A tab, rib, or other member 870 extends from a surface of the recess 868 and is operable to engage and apply a force to the sensor feature 858, thereby causing the sensor feature 858 to translate within its slot 860.

In operation, as the toddler seat 10h is installed onto a support base 20e with the disablement assembly 810 in the upright position, at least one of the sensor member 850 and the first lock member lock release 866 is operable to transition the block member lock 832 from the locked position to an unlocked position. During this installation, the sensor feature 858 is received within the recess 868 of the first lock member lock release 866. The rib 870 engages and applies a force to the sensor feature 858 causing the sensor feature 858 to translate within the slot 860 relative to the seat body 801 and also causing the sensor member 850 to rotate about its axis R (e.g., counterclockwise in the perspective of FIGS. 40-41). As a result, the engagement feature 856 is also rotated to press against the block member lock 832 in response to this translation. Consequently, the engagement feature 856 applies a force to the block member lock 832 that is sufficient to overcome all opposed forces holding the block member lock 832 in the first position, thereby moving the block member lock 832 from the first position to a third, intermediate position. The intermediate position is shown in FIG. 41 and may be considered an unlocked position and is located between the locked position and the stowed position along the path of rotation of the block member lock 832. In the intermediate position, the block member lock track 840 is engaged with the second portion 844 of the block member lock track 840. Accordingly, the block member lock 832 is transitionable from the locked position to the unlocked position when the seat 10h is connected to the support base 20e. As the block member 812 transitions from the upright position to the stowed position, the engagement between the block member lock 832 and the second portion of the block member lock track 840 causes the block member lock 832 to rotate against the biasing force of the biasing member to a collapsed or stowed position.

As the block member 812 rotates toward the stowed position, the block member 812 approaches the second end 854 of the sensor member 850. As shown, a second lock groove 872 may be formed at the side of the block member 812 directly adjacent to the first lock groove 834. The second end 854 of the sensor member 850 including the engagement feature 856 is receivable within the second lock groove 872, such as when the disablement assembly 810 approaches and/or is in the stowed position for example.

In some embodiments, toddler seat 10h is only separable from the support base 20e when the toddler seat 10h is locked in the second configuration, such as when the block member 812 is locked in the upright position. Accordingly, to separate the toddler seat 20h from the support base 20a, a user will rotate the block member from stowed configuration to an upright configuration. As the seat body 801 is lifted relative to the support base 20e, the rib 870 will separate from the sensor feature 858. As a result, the sensor member 850 will translate within the slot 860 back to its original position. This translation causes the second end 854 and the engagement feature 856 of the sensor member 850 to move, allowing the second end 838 of the block member lock 832 to slidably bias into engagement with the first portion 842 of the block member lock track 840, thereby locking the block member 812 in the upright position. In other embodiments, the toddler seat 10h may be separable from the support base 20e before the block member 812 is locked in the upright position, and the block member is arranged to automatically move to the upright position after separation (for example by spring bias).

The disablement assembly 810 may alternatively or additionally include a second lock 880, also referred to herein as a block seat lock. The block seat lock 880 includes an elongated body and is movably connected to the seat body 801. For example, the block seat lock 880 may be pivotally coupled to the seat body 801 and rotatable about an axis between an unlocked position and a locked position. The axis of rotation of the block seat lock 880 may be oriented at a non-parallel angle, and in some embodiments generally perpendicular, to the axis of rotation of the block member lock 832. A biasing mechanism (not shown), such as a coil spring for example, may be operably coupled to the block seat lock 880. In an embodiment, the biasing force of the biasing mechanism is operable to bias the block seat lock 880 toward the locked position.

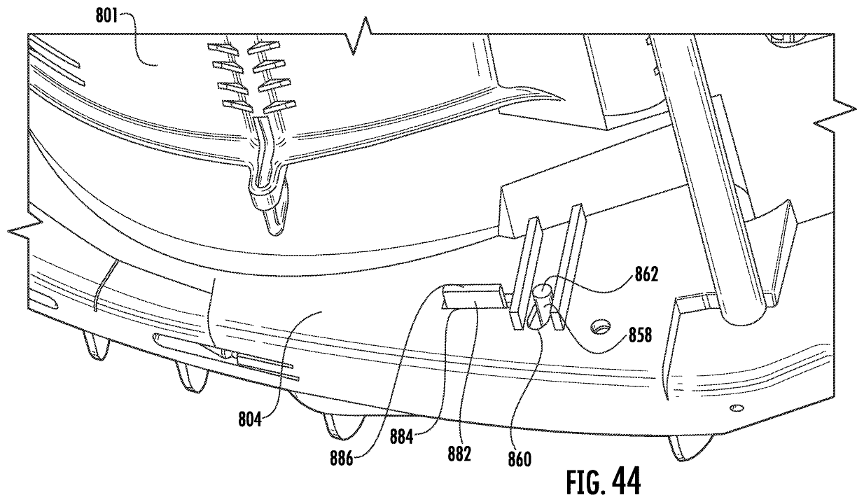

A seat lock feature 882 extends from a portion of the block seat lock 880. When the block seat lock 880 is in the locked position, the seat lock feature 882 extends through an opening 884 formed in the seat body 801 (FIG. 44) such that a distal end 886 of the seat lock feature 882 is arranged at an exterior surface of the seat body 801 configured to face a surface of the support base 20e.

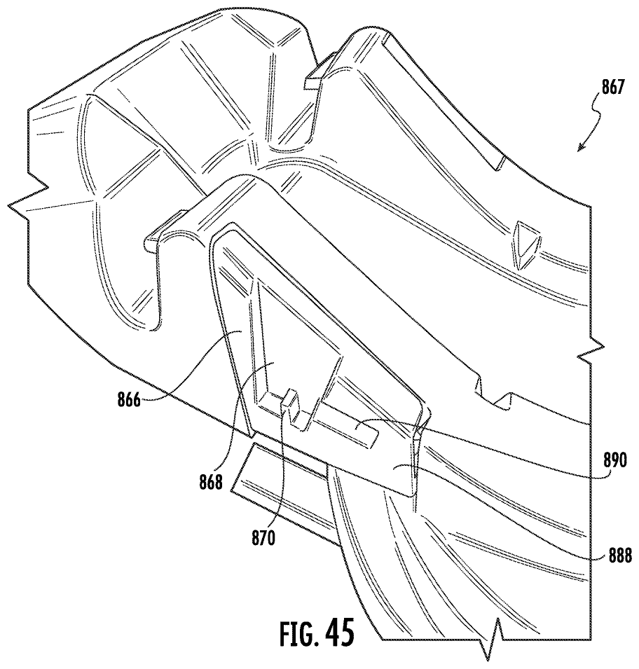

A block seat lock release 888 may be arranged at an exterior surface of the support base 20e. The block seat lock release 888 may be positioned in alignment with the opening 884 formed in the seat body 801. In an embodiment such shown in FIG. 45, the block seat lock release 888 is arranged at an exterior surface of a seat attachment, similar to seat attachment 60 of FIGS. 1-6. In embodiments of the disablement assembly 810 including both the block member lock 832 and the block seat lock 880, the block seat lock release 888 may be separate from or may be integrally formed with the first lock member lock release 866. In the illustrated, non-limiting embodiment, the block seat lock release 888 includes a recess 890 within which the seat lock feature 84 is receivable. Engagement between the seat lock feature 882 and the recess 890 restricts vertical movement of the toddler seat 10h from the support base 20e.

The block seat lock 880 is operably coupled to the block member 812. In the illustrated, non-limiting embodiment, a portion of the block seat lock 880, such as a first end 892 thereof, is positioned generally adjacent to a leg 816 of the block member 812. In an embodiment, a portion of the block seat lock 880 is configured to cooperate with a corresponding portion of the block member 812, such as a surface of a leg 816 for example, to rotate the block seat lock 880 against the bias of the biasing mechanism to the unlocked position. For example, a surface 894 of the leg 816 configured to engage the block seat lock 880 may be a cam surface (FIG. 37A). Accordingly, as the block member 812 rotates from the upright position toward the stowed position, the cam surface 894 gradually reduces the force applied to the block seat lock 880. As a result, the biasing force of the biasing mechanism rotates the block seat lock 880 toward the locked position and into engagement with the recess 890. Similarly, as the block member 812 is rotated from the stowed position towards the upright position, the cam surface 894 applies an increasing force to the block seat lock 880, thereby causing the block seat lock 880 to pivot about its axis in a direction opposing the biasing mechanism. Accordingly, rotation of the block member 812 towards the upright position causes the seat lock feature 882 to disengage or separate from the recess 890 of the block seat lock release 888 and in some embodiments from the opening 884 formed in the seat body 801.

In embodiments of the disablement assembly 810 including both the block member lock 832 and the block seat lock 880, the block member lock 832 and the block seat lock 880 may not be directly coupled to one another. Rather, in such embodiments they are simply both operably coupled to the same block member 812. Although a single actuation assembly 860 is illustrated as being arranged adjacent to a first leg 816 of the block member 812, it should be appreciated that embodiments where a second actuation assembly is arranged adjacent to a second leg 816 of the block member 812 are also within the scope of the disclosure. Further embodiments where the block member lock 832 and sensor member 850 of an actuation assembly 830 are associated with a first leg 816 of the block member 812 and the block seat lock 880 of the same actuation assembly is associated with the second leg 816 of the block member 812 are also contemplated herein.

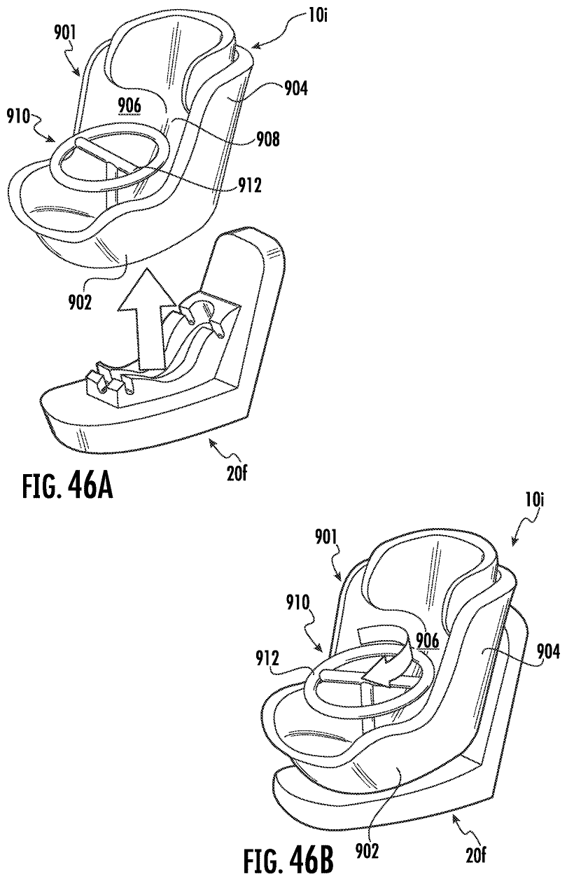

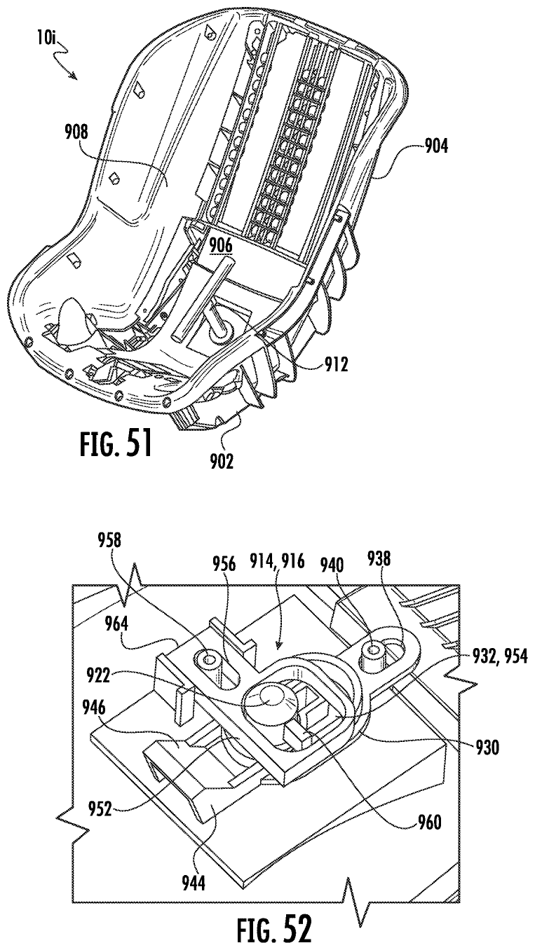

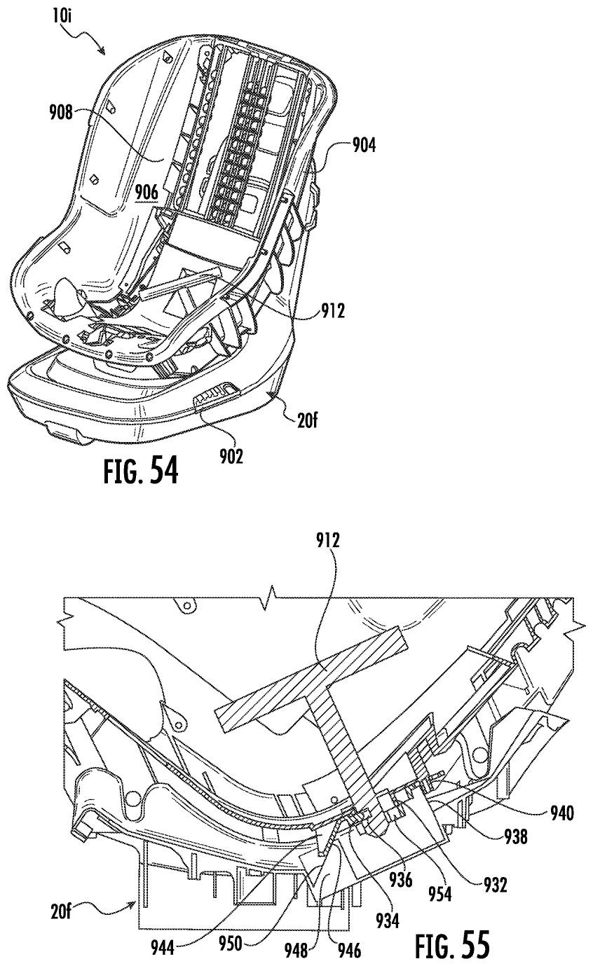

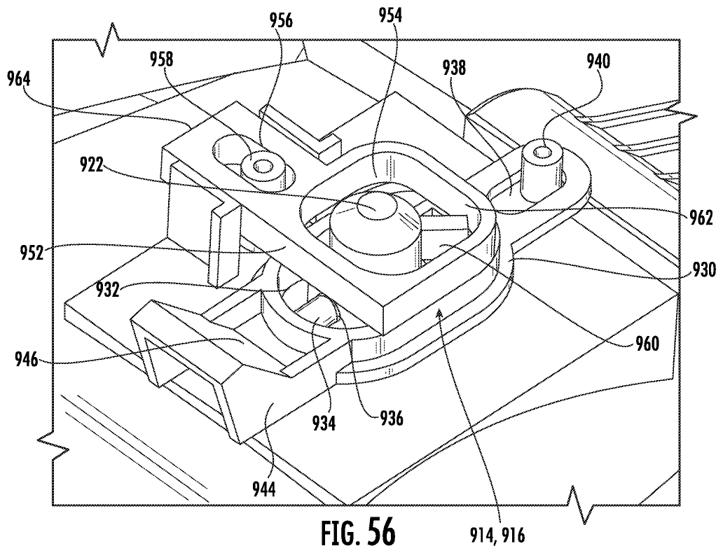

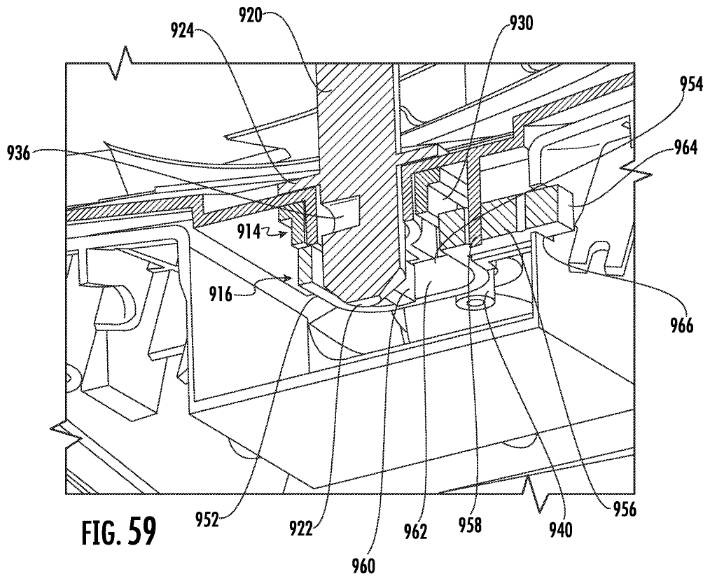

With reference to FIGS. 46-61, the illustrated child seat system similarly includes a toddler seat 10i and a support base 20f. The toddler seat 10i includes a seat body 901 having a seat portion 904 and a back portion 902 extending in an upward direction from the seat portion 904. The toddler seat 10i has a seating area 906 sized to support a child therein. The seating area 906 may be defined by the back portion 902, the seat portion 904, or a combination of both the back portion 902 and the seat portion 904. In an embodiment, an inner seat surface 908 defines a portion of the seating area 906. The inner seat surface 908 may be located at a surface of the back portion 902, the seat portion 904, or a combination of both the back portion 902 and the seat portion 904.

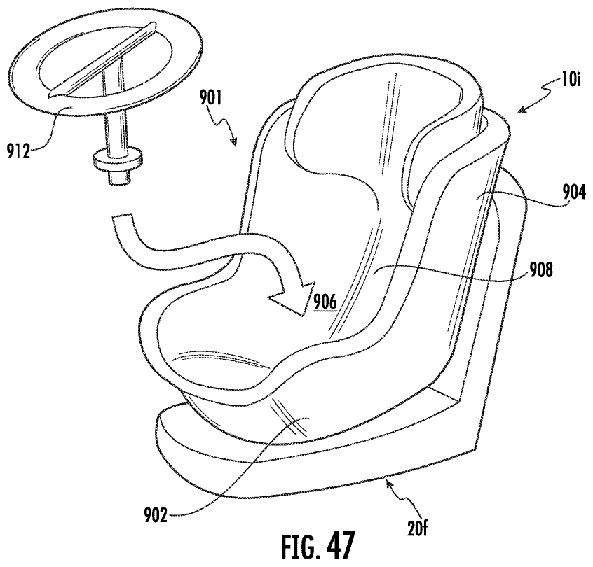

In an embodiment, the seat portion 904 includes a disablement assembly 910 connected thereto. The disablement assembly 910 may be configured to transition between a first configuration (FIGS. 46A, 51 and 52) and a second configuration (FIGS. 47, 60 and 61). In the first configuration, the seat portion 904 is in an occupant preventing configuration in which the seat is substantially prevented from receiving and supporting a child thereon. In the second configuration, the toddler seat 10i is in an occupant receiving configuration meaning that the seat can receive and support a child seated on the seat portion 904. Alternatively, or in addition, the toddler seat 10i may be prevented from being detached from the support base 20f when the disablement assembly 910 is in the second configuration, and the toddler seat 10i may be free to be detached from the support base 20a when the disablement assembly 910 is in the first configuration.

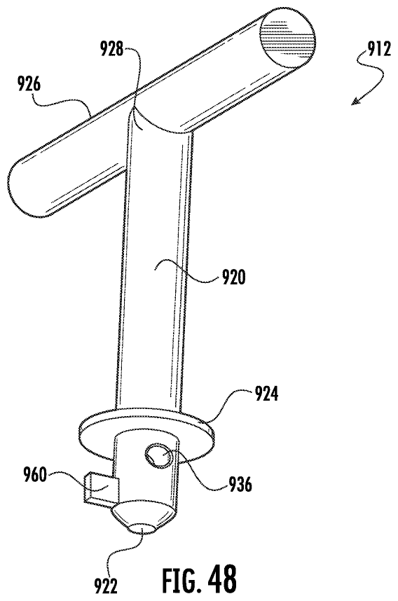

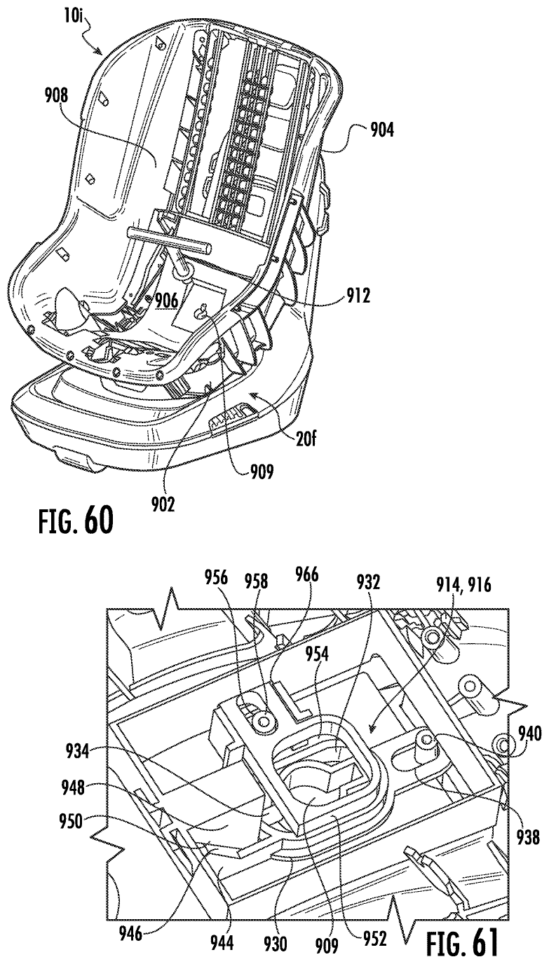

In the illustrated, non-limiting embodiment, the disablement assembly 910 includes a tool 912, a first lock 914 movable to selectively engage the tool 912, and a second lock 916 movable to selectively engage the support base 20f. An example of the tool 912 of the disablement assembly 910 is illustrated in FIG. 48. As shown, the tool 912 may include a stem or shaft 920 having a first end 922 insertable through an opening 909 (see FIG. 60) formed in a portion of the toddler seat 10i, such as the seat portion 904 for example. Accordingly, when the tool 912 is connected to the toddler seat 10i, the tool 912 is present in the seating area 906, thereby preventing a child from being received within the seating area 906. In an embodiment, the tool 912 (also referred to as a key) is connectable to the seat body 901 to render the toddler seat 10i unusable, e.g., take up some or all of the space that a child occupant would use and/or block component(s) of the harness from being fastenable. In the illustrated, non-limiting embodiment, the tool 912 is also used for enabling the toddler seat 10i to be removed from the support base 20f.

The tool 912 may include a positioning member 924, such as a flange for example, configured to abut a surface of the toddler seat 10i to properly position the tool 912 relative to the remainder of the disablement assembly 910. In some embodiments, the tool 912 may include a grasping feature 926 intended facilitate movement of the tool 912 by a user, such as a circular handlebar (FIGS. 46A-47) or a straight handlebar (FIG. 48) for example. Although the grasping feature 926 is illustrated as being arranged at the second, opposite end 928 of the stem 920, embodiments where a grasping feature 926 is alternatively or additionally arranged at another location about the tool are within the scope of the disclosure.

Arranged at the underside of the seat body 901, such as at the seat portion 904 for example, is the first lock 914 and the second lock 916. The first lock 914 and the second lock 916 may be arranged in a stacked or overlapping relationship relative to an axis of the tool 912. In an embodiment, the first lock 914 is movable to selectively couple to or engage the tool 912, thereby restricting separation of the tool 912 from the first lock 914 and the seat body 901. Accordingly, the first lock 914 may be considered a tool lock. In an embodiment, the second lock 916 is movable to selectively couple to or engage the support base 20f, thereby restricting separation of the toddler seat 10i from the support base 20f. Accordingly, the second lock 916 may be considered a seat lock.

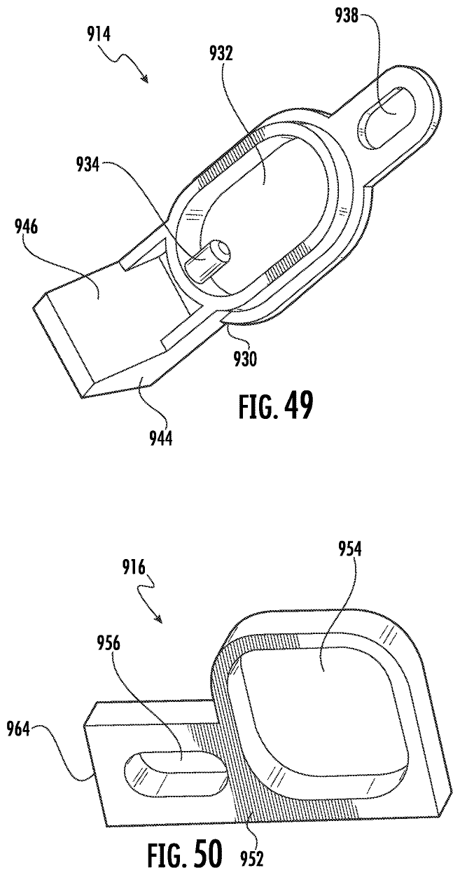

With reference to FIG. 49, in the illustrated, non-limiting embodiment, the first lock 914 includes a body 930 having an opening or through hole 932 formed therein. A portion of the tool 912, such as the stem 920 for example, is receivable within the opening 932. As shown, the first lock 914 may include a tool engagement feature 934 operable to engage a portion of the tool 912. In the illustrated, non-limiting embodiment, the tool engagement feature 934 is a protrusion receivable within a corresponding hole 936 formed in the tool 912, such as in the stem 920 for example. However, embodiments where the tool engagement feature 934 is a hole or groove and the tool 912 includes a protrusion receivable within the hole are also within the scope of the disclosure. It should be appreciated that the interface between the tool engagement feature 934 and the tool 912 is intended as an example only and that any suitable interface or connection is contemplated herein.

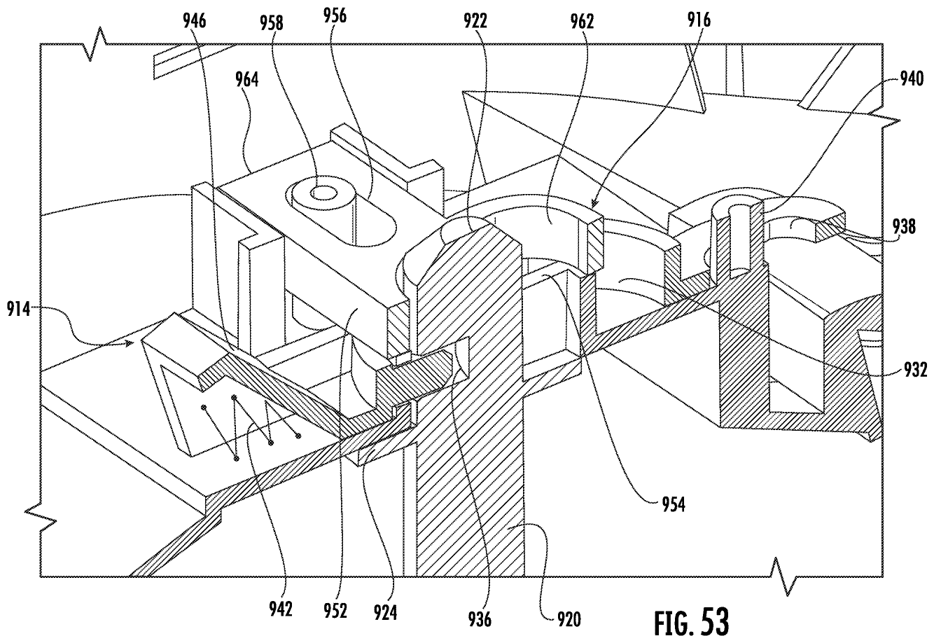

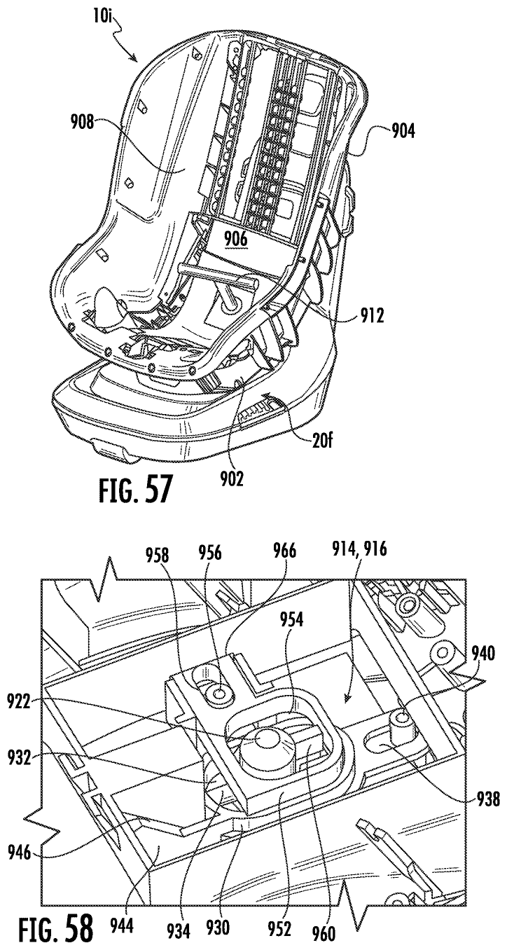

The body 930 of the first lock 914 may additionally include a first pin slot 938. In an embodiment, the first lock 914 is mounted relative to the seat body 901 such that a first locking pin 940 (see FIG. 52) extending from the seat body 901 is arranged within the first pin slot 938. This engagement between the first locking pin 940 and the first pin slot 938 defines the allowable movement of the first lock 914 relative to the seat body 901 between a first locked position (FIG. 52) and a first unlocked position (FIG. 58). When the first lock 914 is in the first locked position and the tool 912 is arranged within the opening 932, the tool engagement feature 934 is engaged with the tool 912. When the first lock 914 is in the first unlocked position, the tool engagement feature 934 is separated or disengaged from the tool 912. When the tool engagement feature 934 is separated from the tool 912, the tool 912 is movable relative to the seat body 901. For example, the tool 912 may be rotated. Alternatively, or additionally, the tool 912 may be removed, for example axially translated, relative to the opening 932 formed in the first lock 914, such as to separate the tool 912 from the seat body 901. A biasing mechanism, illustrated schematically at 942 in FIG. 53, may be operably coupled to the first lock 914. In such embodiments, the biasing mechanism 942, such as a spring for example, may be operable to bias the first lock 914 toward the first locked position.

The first lock 914 may alternatively, or additionally, include a movement feature 944. In the illustrated, non-limiting embodiment, the first pin slot 938 and the movement feature 944 are disposed at opposite sides of the opening 932. However, embodiments where the first pin slot 938 and the movement feature 944 are arranged at another location about the body 930 of the first lock 914 are also within the scope of the disclosure. In an embodiment, the movement feature 944 includes a ramp having an angled or sloped surface 946 that extends out of the plane of the opening 936. In an embodiment, the biasing mechanism 942 may be configured to contact a portion of the movement feature 944.

In an embodiment, such as shown in FIGS. 55 and 58, the support base 20f has a lock movement feature 948 having a non-planar configuration. An engagement surface 950 of the lock movement feature 948 may have an angle or slope, such as complementary to the surface 946 of the movement feature 944 of the first lock 914. As a result, the forces resulting from engagement between the movement feature 944 and the lock movement feature 948 oppose the biasing force of the biasing mechanism 942 operably coupled to the first lock 914. Accordingly, engagement between the movement feature 944 and the lock movement feature 948, such as during installation of the child seat 20i onto the support base 20f for example, is configured to transform the first lock 914 from the first locked position to the first unlocked position.

With reference now to FIG. 50, the second lock 916 similarly includes a body 952 having an opening 954, and during use a portion of the tool 912, such as the first end 922 thereof for example, is receivable within the opening 954. The body 952 of the second lock 916 may additionally include a second pin slot 956. In an embodiment, the second lock 916 is mounted relative to the seat body 901 such that a second locking pin 958, such as extending from the seat body 901 for example, is arranged within the second pin slot 956. This engagement between the second locking pin 958 and the second pin slot 956 defines the allowable movement of the second lock 916 relative to the seat body 901 between a second unlocked position (FIG. 52) and a second locked position (FIG. 58). Although not shown, a biasing mechanism may be operably coupled to the second lock 916. In such embodiments, the biasing mechanism, such as a spring for example, may be operable to bias the second lock 916 toward the second locked position.

As shown, the opening 954 of the second lock 916 is axially aligned with the opening 932 of the first lock 914. In an embodiment, the first lock 914 is positioned between the seat body 901 and the second lock 916. However, embodiments where the second lock 916 is positioned between the seat body 901 and the first lock 914 are also within the scope of the disclosure.

In an embodiment, movement, for example rotation, of the tool 912 is operable to oppose the bias of the biasing mechanism operably coupled to the second lock 916. As shown in FIG. 48, the tool 912 may include a lock engagement member 960 configured to cooperate with a sidewall 962 defining the opening 954 of the second lock 916. In the illustrated, non-limiting embodiment, the lock engagement member 960 is a rib or other protrusion extending outwardly from an exterior of the tool 912. When the tool 912 is in a first configuration (see FIG. 52), such as at a first rotational position for example, the engagement between the lock engagement member 960 and the second lock 916 opposes the biasing force of the biasing mechanism associated therewith. In an embodiment, in the first configuration, the tool engagement feature 934 of the first lock 914 is engaged or engageable with the hole 936 formed in the tool 912.

When the tool 912 is moved to a second configuration, such as to a second rotational position for example, the lock engagement member 960 is moved away from the sidewall 962, thereby causing the bias of the biasing mechanism to move the second lock to the second locked position. The selective engagement between the lock engagement member 960 may be achieved by controlling one or more of the location of the tool 912 relative to the center of the opening 954 of the second lock 916, the contour of the lock engagement member 960, and the contour of the opening 954. For example, in the illustrated, non-limiting embodiment, the tool 912 is located at a position offset from a center of the opening 954 of the second lock 916.

When the toddler seat 10i is separated from the support base 20f, the tool 912 is connected to the toddler seat 10i. In the illustrated, non-limiting embodiment, the tool 912 is arranged within the opening 932, 954 of both the first lock 914 and the second lock 916, respectively, and the tool engagement feature 934 of the first lock 914 is engaged or operably coupled to the tool 912. The tool 912 is not separable from the toddler seat 10i in such a configuration. When the toddler seat 10i is properly positioned about the support base 20f, a portion of the second lock 916, such as the end 964 thereof adjacent to the second pin slot 956 for example, is aligned with an opening 966 formed in a wall of the support base 20f. As noted above, as the toddler seat 10i is positioned about the support base 20f, the engagement between the movement feature 944 of the first lock 914 and the lock movement feature 948 of the support base 20f causes the first lock 914 to translate from the first locked position to the first unlocked position. With the tool engagement feature 934 separated from the tool 912, the tool 912 can be rotated by a user from the first configuration toward the second configuration.

As the tool 912 moves towards the second configuration, the force opposing the biasing mechanism associated with the second lock 916 is reduced. As a result, the biasing force of the biasing mechanism associated with the second lock 916 moves the second lock 916 to the second locked position. The second lock 916 may be configured to translate between the second unlocked position and the second locked position. In the illustrated, non-limiting embodiment, the second lock 916 is configured to translate through the opening 966 formed in the support base 20f. Accordingly, in the second locked position, the second lock 916 is engaged and operably coupled to the support base 20f, thereby restricting separation of the toddler seat 10i from the support base 20f.

To decouple the toddler seat 10i from the support base 20f, the tool 912 must be inserted into the opening 909 (as shown in FIG. 60) in the second configuration and then moved, for example rotated, to the first configuration. As the tool 912 transforms to the first configuration, the lock engagement member 960 is moved into contact with a surface of the second lock. As the force generated by this engagement increases, the force opposes the biasing force acting on the second lock 916 and moves the second lock 916 from the opening 966 in the support base 20f. Once the tool 912 is used to transform the second lock 916 to the second unlocked position, the toddler seat 10i may be lifted away from or out of engagement with the support base 20f. In an embodiment, as the toddler seat 10i separates from the support base 20f, the lock movement feature 948 is moved away from movement feature 944. Accordingly, the biasing force of the biasing mechanism acting on the first lock 914 biases the tool engagement feature 934 into engagement with the tool 912, thereby locking the tool 912 to the seat body 901. Accordingly, the toddler seat 10i is removable or separable from the support base 20f when the tool 912 is connected to the seat 10i, for example inserted into the opening 909 and locked to the toddler seat 20i via the first lock 914. Similarly, the toddler seat 10i is not separable from the support base 20f when the tool 912 is not positioned within the hole 909 or is not locked to the seat via the first lock 914.

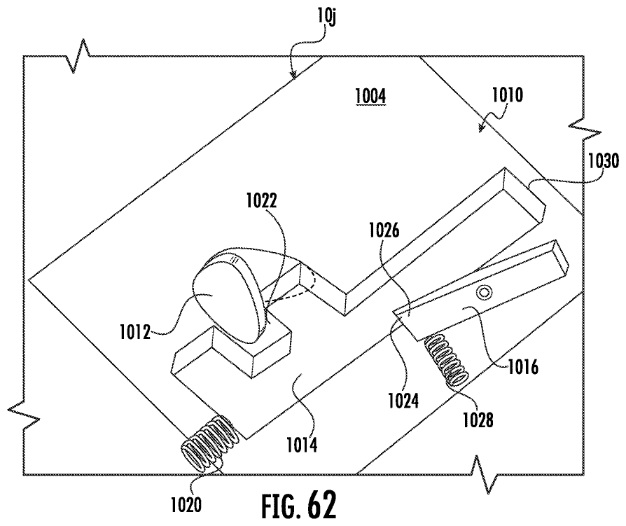

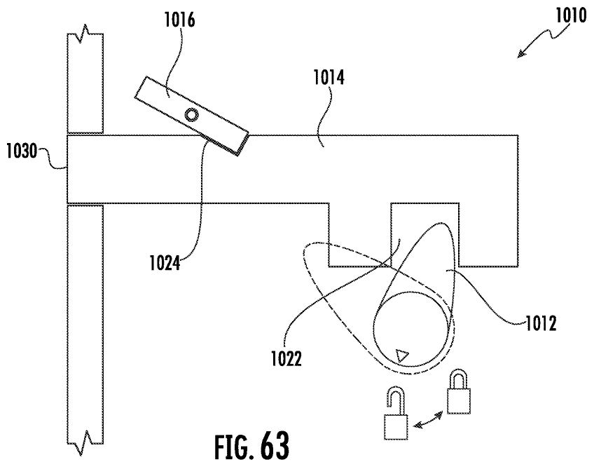

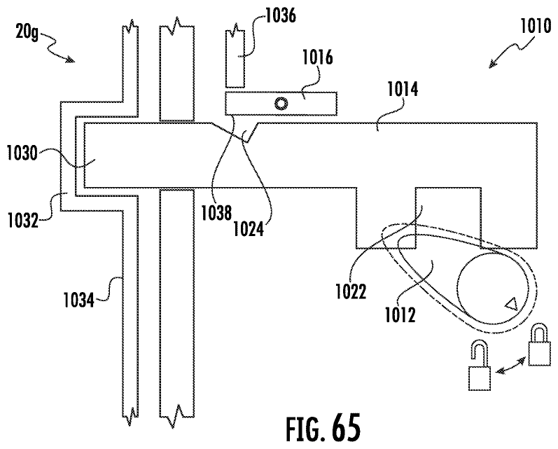

With reference now to FIGS. 62-65, another embodiment of a disablement assembly 1010 is illustrated. As shown, the toddler seat 10j includes a first lock 1014 and a second lock 1016 arranged at an underside of the seat portion 1004. The first lock 1014 may be slidable relative to the seat portion 1004 between an unlocked position (FIG. 63) and a locked position (FIG. 65). Further, a biasing mechanism 1020 operably coupled to the first lock 1014, such as a coil or torsion spring for example, may bias the first lock 1014 toward the locked position.

The first lock 1014 may have a first groove 1022 arranged at a first side thereof configured to cooperate with a tool 1012. The tool 1012 selectively receivable within an opening (not shown) formed in the seat 10j is engageable with or receivable within the groove or recess 1022 formed in the first lock 1014. In an embodiment, movement of the tool 1012, for example rotation thereof, is operable to apply a force to the first tool 1014 in a direction opposite the biasing force of the biasing mechanism 1020. Accordingly, the tool 1012 may be operated to transition the first lock 1014 from the locked position to the unlocked position.

In an embodiment, a second groove or recess 1024 is formed at a second side of the first lock 1014 and therefore a portion of the second lock 1016, such as an end 1026, is receivable within the second recess 1024 to engage the first lock 1014. Engagement between the first lock 1014 and the second lock 1016 restricts movement of the first lock 1014 from the unlocked position. In an embodiment, a biasing mechanism 1028 is operably coupled to the second lock 1016 to bias the second lock 1016 into engagement with the first lock 1014.

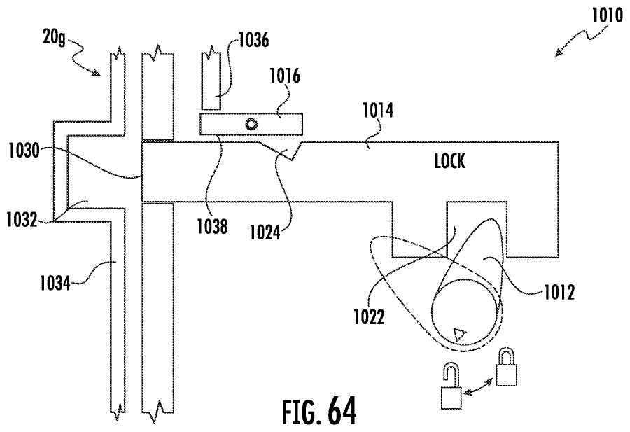

As shown in FIG. 63, when the toddler seat 10j is separated from the support base 20g, the tool 1012 is operably coupled to the first lock 1014. Further, the second lock 1016 is engaged with the first lock 1014, thereby retaining the first lock 1014 in the unlocked position. Upon installation of the toddler seat 10j onto the support base 20g, as shown in FIG. 64, an end 1030 of the first lock 1014 is aligned with an opening 1032 formed in a wall 1034 of the support base 20g. In addition, a portion of the support base 20g, such as a lock engagement feature 1036 for example, engages a distal end 1038 of the second lock 1016. The engagement between the lock engagement feature 1036 and the second lock 1016 causes the second lock 1016 to move, for example rotate about an axis, out of engagement with the first lock 1014. In this rotated position, the first lock 1014 is free to move or translate between the locked and unlocked position. The tool 1012 may be rotated causing the end 1030 of the first lock 1014 to transition to the locked position. In the locked position, the end 1030 of the first lock 1014 extends through the opening 1032 formed in the support base 20g, thereby coupling the toddler seat 10j to the support base 20g. Once in the locked position, the tool 1012 may be separated from the toddler seat 10j. However, to decouple the toddler seat 10j from the support base 20g, the tool 1012 must be reinserted and rotated to oppose the force of the biasing mechanism 1020, thereby causing the first lock 1014 to translate to the unlocked position. In an embodiment, the tool cannot be separated from the toddler seat 10j and/or first lock 1014 when in this position. With the tool 1012 remaining in this position, as the toddler seat 10j is separated from the support base 20g, the lock engagement feature 1036 will separate from the second lock 1016. As a result, the biasing force of the biasing mechanism 1028 operably coupled to the second lock 1016 will bias the second lock into engagement with the first lock 1014 to retain the first lock in the unlocked position. Accordingly, the toddler seat 10j is removable or separable from the support base 20g when the tool 1012 is connected to the seat 10j, and the toddler seat 10j is not separable from the support base 20g when the tool 1012 is not connected to the toddler seat 10j.

The term “about” is intended to include the degree of error associated with measurement of the particular quantity based upon the equipment available at the time of filing the application. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A child seat system installable on a vehicle seat, the child seat system comprising:
a support base securable to the vehicle seat; and
a seat detachably connectable to the support base, the seat including:
a seat portion, and
a back portion extending in an upward direction from the seat portion,
wherein said seat is configured to transition between a first configuration and a second configuration, in said first configuration, said seat can receive and support a child seated on the seat portion, and in said second configuration, said seat is unable to receive or support the child on said seat portion,
wherein said seat is configured to transition from said second configuration to said first configuration by connecting said seat to said support base.

2. The child seat system of claim 1, wherein said seat comprises a toddler seat.

3. The child seat system of claim 2, further comprising an infant car seat detachably connectable to said support base.

4. The child seat system of claim 1, wherein the seat has an inner seat surface that defines a seating area, said seating area being sized to support the child within, wherein said seat further includes a block member, wherein in said first configuration, said block member is outside of said seating area, and wherein in said second configuration, said block member extends at least partially into said seating area.

5. The child seat system of claim 4, wherein said seating area is at least partially defined by said seat portion.

6. The child seat system of claim 5, wherein said seating area is at least partially defined by said back portion.

7. The child seat system of claim 4, wherein in said first configuration, said block member is positioned within a recess defined by said back portion.

8. The child seat system of claim 4, wherein in said first configuration, said block member is positioned within a recess defined by said seat portion.

9. The child seat system of claim 4, wherein said block member is rotatable relative to said seat.

10. The child seat system of claim 4, wherein said block member defines a general U-shape, said block member including opposing ends connected to said seat and a handle portion positioned between said opposing ends, wherein in said second configuration, said handle portion is accessible by a user to lift said seat.

11. The child seat system of claim 4, wherein when said seat is disconnected from said support base, said seat is locked in said second configuration.

12. The child seat system of claim 4, wherein said seat further includes a first lock, wherein said first lock is configured to transition between an unlocked position and a locked position, wherein in said unlocked position, said block member is free to move relative to said seat, and wherein in said locked position, said block member is substantially prevented from moving relative to said seat, said first lock being transitionable from said locked position to said unlocked position when said seat is connected to said support base.

13. The child seat system of claim 12, wherein when said seat is detached from said support base said first lock is prevented from transitioning from said locked position to said unlocked position.

14. The child seat system of claim 12, wherein said seat further includes a sensor member, said sensor member being configured to transition said first lock from said locked position to said unlocked position.

15. The child seat system of claim 12, wherein said support base includes a lock member lock release, said lock member lock release being operatively connectable to said first lock such that said lock member lock release transitions said first lock from said locked position to said unlocked position when said seat is connected to said support base.

16. The child seat system of claim 1, wherein when said seat is connected to said support base, said seat is prevented from being detached from said support base when said seat is in said first configuration, and wherein said seat is free to be detached from said support base when said seat is in said second configuration.

17. A child seat detachably connectable to a support base, the support base being installable on a vehicle seat, the child seat comprising:
a seat body having an inner surface that defines a seating area, said seating area being sized to support a child within, and
a block member connected to said seat body;
wherein the child seat is configured to transition between a first configuration and a second configuration, in the first configuration said block member is in a first position outside of said seating area and the child seat can receive and support the child within said seating area, and in the second configuration said block member is in a second position at least partially extending into said seating area and the child seat is unable to receive or support the child within said seating area;
wherein the child seat is configured to transition from said second configuration to the first configuration by connecting said seat to said support base.

18. A support base for detachably receiving a child seat thereon, the support base being installable on a vehicle seat, the child seat including a seat body defining a seating area sized to receive a child, and a disablement assembly connected to the seat body, the disablement assembly configured to transition between a first configuration in which the child is receivable within the seating area, and a second configuration in which the child is not receivable within the seating area, the support base comprising:
a support base body having a lock member lock release operatively connectable to the disablement assembly, wherein when the child seat is connected to the support base, said lock member lock release transitions a first lock of the disablement assembly from a locked position to an unlocked position, wherein in the unlocked position the disablement assembly is free to transition from the second configuration to the first configuration.

19. A child seat system installable on a vehicle seat, the child seat system comprising:
a support base securable to the vehicle seat; and
a seat detachably connectable to said support base, said seat including:
a seat body having an inner surface that defines a seating area, said seating area being sized to support a child within; and
a block member connected to said seat body;
wherein the child seat is configured to transition between a first configuration and a second configuration, in said first configuration said block member is in a first position outside of said seating area and said seat can receive and support the child within said seating area, and in said second configuration said block member is in a second position at least partially extending into said seating area and said seat is unable to receive or support the child within said seating area;
wherein said seat is configured to transition from said second configuration to said first configuration by connecting said seat to said support base.

20. The child seat system of claim 19, wherein said seat further includes a first lock, wherein said first lock is configured to transition between an unlocked position and a locked position, wherein in said unlocked position, said block member is free to move relative to said seat, and wherein in said locked position said block member is substantially prevented from moving relative to said seat.

21. The child seat system of claim 20, wherein said first lock is operatively connectable to said support base such that said first lock is transitionable from said locked position to said unlocked position when said seat is connected to said support base.

22. The child seat system of claim 20, wherein said seat further includes a second lock, wherein said second lock is configured to transition between an unlocked position and a locked position, wherein in said unlocked position, said seat is detachable from said support base, and wherein in said locked position, said seat is prevented from being detached from said support base.

23. The child seat system of claim 22, wherein said second lock is operatively connected to said block member such that said second lock is transitionable from said locked position to said unlocked position when said block member transitions from said first position to said second position.

24.-43. (canceled)
